(19) United States
(12) Patent Application Publication
(10) Pub. No.: US 2025/0299607 A1
(43) Pub. Date: Sep. 25, 2025

(54) SOLAR ARRAY ASSEMBLY INCORPORATING VISUAL DISPLAYS

(71) Applicant: Rev Solar LLC, Alexandria, VA (US)

(72) Inventors: Robert Gregory Twiss, Chapel Hill, NC (US); R. Allen Gilstrap, Alexandria, VA (US)

(21) Appl. No.: 19/089,637

(22) Filed: Mar. 25, 2025

Related U.S. Application Data
(60) Provisional application No. 63/569,686, filed on Mar. 25, 2024.

(51) Int. Cl. G09G 3/00; G03B 21/58; G06Q 30/0202; G06Q 50/06; H02J 3/46; H02S 50/00

(52) U.S. Cl. CPC G09G 3/001; G03B 21/58; G06Q 30/0202; G06Q 50/06; H02J 3/46; H02S 50/00; G09G 2320/0626; G09G 2330/021; H02J 2300/24

(57) ABSTRACT

Systems described herein may include one or more solar power modules that may be arranged in an array and may additionally display superimposed static (e.g., fixed) text, symbols, and/or images. Such superposition may be accomplished by adhering substances directly to surface(s) of the one or more solar power modules and/or to an interposed body. Additionally or alternatively, systems described herein may include one or more solar panel modules integrated with display systems configured to display dynamically programmable superimposed text, symbols, and/or images through an interposed display screen.

### PRIORITY CLAIM

This application claims priority to provisional application 63/569,686 (filed Mar. 25, 2024), which is hereby incorporated by reference in its entirety.

### TECHNICAL FIELD

The present disclosure relates to solar power generation, and, more particularly, enhancing solar power panels and panel array assemblies to display superimposed static and/or dynamically programmable text, symbols, and/or images.

### BACKGROUND

From its inception in 1884, solar power generation has accelerated to now over a one Tera-Watt capacity globally. Modern solar generation involves aggregating solar producing “cells” into multi-cellular rectangular panels that are conveniently mounted in grid-like multi-panel arrays placed on rooftops, on open land, etc. Solar power is an attractive power generation option for many reasons including avoiding chemical or noise emissions in operation. In addition, material science advances have steadily increased power generation per unit panel area and have also enabled other convenient solar cell formats such as “thin film,” opening new cell and module mounting schemes.

Despite these advantages and advances, solar power remains a niche or an uncompelling business option in too many applications, stunting wider adoption. What is desired is a method that retains solar power generation advantages but improves the return-on-investment equation through enabling increased revenue-generating opportunities.

### SUMMARY

A solar array display system as described herein may comprise a plurality of solar modules configured to convert solar energy into electrical power, at least one display operably connected to the plurality of solar modules, wherein the at least one display is configured to present visual content, and a control system operably coupled to the plurality of solar modules and the at least one display. The control system may comprise a power management system configured to monitor power generation of the plurality of solar modules, control power allocation between the plurality of solar modules and the at least one display. The control system may further comprise a content management system configured to store visual content for display on the at least one display, select a subset of the visual content based on at least one operational parameter of the solar array display system, and control presentation of the selected subset of visual content on the at least one display. In embodiments, the control system is configured to dynamically balance power generation by the plurality of solar modules and presentation of visual content by the at least one display based on at least one operational priority.

In some embodiments, the power management system is further configured to adjust positioning of at least one of the plurality of solar modules to balance power generation and display visibility. Additionally or alternatively, the at least one display comprises a transparent or semi-transparent display positioned over at least one of the plurality of solar modules. Additionally or alternatively, the at least one display comprises a peripheral display mounted to an edge portion of a supporting structure that holds the plurality of solar modules.

In some embodiments, the at least one display comprises a pole-mounted display connected to a support pole that supports the plurality of solar modules. In some of these embodiments, the pole-mounted display is configured to articulate independently of the plurality of solar modules.

In some embodiments, the at least one display comprises a projector configured to project visual content onto at least one of: the plurality of solar modules or a deployable screen. In some of these embodiments, the system further comprises a deployable screen movable between a stowed position and a deployed position covering at least a portion of the plurality of solar modules.

In some embodiments, the at least one operational parameter comprises at least one of current power generation, stored power level, time of day, weather conditions, display visibility, or content priority. Additionally or alternatively, the at least one operational priority comprises at least one of power generation priority, revenue generation priority, or information display priority. Additionally or alternatively, the content management system is further configured to select the subset of the visual content based at least partially on a power consumption impact of the visual content. Additionally or alternatively, the control system is further configured to override current operational priorities in response to receiving emergency notification content for display. Additionally or alternatively, the control system is further configured to communicate with external systems to receive content for display or operational instructions. Additionally or alternatively, the system further comprises a storage system configured to store excess power generated by the plurality of solar modules. Additionally or alternatively, the solar array display system is one of a plurality of solar array display systems in a networked installation, and wherein the content management system is configured to coordinate visual content across the plurality of solar array display systems. Additionally or alternatively, the system further comprises at least one sensor configured to collect data related to at least one of ambient light conditions, solar irradiance, or viewer presence, wherein the content management system is configured to select the subset of the visual content based at least partially on data from the at least one sensor. Additionally or alternatively, the content management system is further configured to adjust brightness of the at least one display based on current power generation by the plurality of solar modules. Additionally or alternatively, the system further comprises a static visual overlay applied to at least a portion of at least one of the plurality of solar modules, wherein the static visual overlay is configured to display static visual content while allowing solar radiation to reach the solar module. Additionally or alternatively, the power management system is further configured to monitor external power grid conditions and adjust the balance between power generation and presentation of visual content based at least partially on the external power grid conditions. Additionally or alternatively, the control system is configured to implement a revenue optimization mode that evaluates potential revenue from power generation versus display of advertising content.

These are only of the some of the features described herein. A more complete understanding of the disclosure will be appreciated from the description and accompanying drawings and the claims, which follow.

### BRIEF DESCRIPTION OF FIGURES

FIG. 1A is a system diagram showing example system components according to embodiments described herein.

FIG. 1B is a frontal perspective view of an example solar array installation including an array mounted to a single pole fixed in a ground level base foundation.

FIG. 1C shows an example solar array display system that includes the elements of FIG. 1B, while also including a static superimposed image on the solar panel array front surface.

FIG. 1D is an example closeup side view of a section of the solar array display system of FIG. 1C, focusing on a central full solar module bracketed by adjacent modules above and below. The modules shown also include a surface pigment that forms the superimposed image illustrated in FIG. 1C.

FIG. 1E is a closeup side view of another example solar array display system similar to the one shown in FIG. 1D, however, the surface pigment is further illustrated applied to the external surface of a platform that is offset-mounted from the solar modules.

FIG. 1F is a similar assembly as shown in FIG. 1E, however, in this case the surface pigment is shown applied to the inside surface of the offset-mounted platform.

FIG. 2A is a frontal perspective view of an example solar array display system (e.g., similar to the array shown in FIG. 1C), however, the superimposed image illustrated is dynamic and programmable, capable of displaying successive static images, or video.

FIG. 2B is the solar array display system of FIG. 2A shown with a different superimposed dynamic image.

FIG. 2C is a closeup side view of an example dynamic image solar array display system (e.g., the array shown in FIG. 2B), focusing on a single solar module and two adjacent modules. Additionally, an active display layer is shown on the face of each solar module.

FIG. 2D is a closeup side view of another example solar array display system similar to the one shown in FIG. 2C, however, the active display layer is illustrated applied to the external surface of a platform offset-mounted from the solar modules.

FIG. 2E is a similar assembly as shown in FIG. 2D, however, in this case the active display layer is shown applied to the inside surface of the offset-mounted platform.

FIG. 2F is a frontal perspective view of an example dynamic image solar array display system (e.g., as seen in FIGS. 2A-2E), further including a wired controller.

FIG. 2G is a frontal perspective view of the dynamic image solar array display system (e.g., as seen in FIGS. 2A-2F), in this case including a wireless controller.

FIG. 2H illustrates a side view of a dynamic image solar array display system (e.g., as described in FIGS. 2A-2G), and incorporating a pole-mounted video camera directed towards the rear of the array.

FIG. 2I demonstrates an example dynamic image solar array display system (e.g., as shown in FIGS. 2A-2H), with the active display showing images captured by the reward-facing camera described in FIG. 2H.

FIG. 3A is a frontal perspective view of an example solar array display system similar to the one shown in FIG. 1B that also incorporates a mounted optical projector displaying static and/or dynamic images directly onto the solar array surface.

FIG. 3B shows an example solar array display system as shown in FIGS. 1B and 3A, however, this embodiment uses a remotely positioned projector to display static and/or dynamic images onto the solar array surface.

FIG. 4A depicts a frontal perspective view of another solar array display system (which may be similar to the system shown in FIGS. 3A and/or 3B), including an array-mounted optical projector and a deployable viewing screen.

FIG. 4B illustrates the solar array display system shown in FIG. 4A with the deployable viewing screen positioned in mid-deployment.

FIG. 4C shows the solar array display system shown in FIGS. 4A and 4B with the deployable viewing screen in the fully deployed position, with static and/or dynamic images being displayed on the screen.

FIG. 4D depicts a side view of the solar array display system shown in FIG. 4A, including an array-mounted optical projector and a deployable viewing screen.

FIG. 4E illustrates the solar array display system shown FIG. 4A with the deployable viewing screen positioned in mid-deployment.

FIG. 4F shows the solar array display system of FIGS. 4D and 4E with the deployable viewing screen in the fully deployed position.

FIG. 4G depicts a side cross-sectional view of the solar array display system shown in FIG. 4E with the deployable screen in mid-deployment, and highlighting the rolled screen storage and roller deployment mechanism.

FIG. 5A is a frontal perspective view of an example solar array display system including a substantially contiguous display surface surrounding the solar array mounting pole, showing static and dynamic content. Such content may be preferentially oriented to accommodate one or more content viewers.

FIG. 5B shows the array of FIG. 5A, with the surrounding display surface movable in a vertical fashion along the array mounting pole. Such motion may be advantageous to more effectively accommodate one or more content viewers.

FIG. 5C depicts the solar array display system of FIGS. 5A and 5B, however, in this case, a fixed panel display is shown displaying static and dynamic content.

FIG. 5D illustrates the solar array display system of FIG. 5B, with the panel display enabled to articulate around the array pole (i.e., a panning motion) and around a horizontal axis (i.e., a tilting motion). Such articulation may prove advantageous to accommodate one or more content viewers, and to compensate for ambient conditions such as external light intensity and direction.

FIG. 6A depicts a solar array display system that combines both array- and pole-based display options for presenting static and dynamic content. Such content may be programmed independently or substantially choreographed.

FIG. 6B shows the solar array display system described in FIG. 6A, with the addition of audio programming provided by one or more speakers.

FIG. 7 shows an installation comprising multiple instances of the solar array display systems shown in FIG. 6B, and networked to provide coordinated visual and audio content over both local and wide geographic installations.

FIG. 8A depicts a frontal perspective view of another solar array display system with a peripheral panel display shown mounted to the lower array edge structure. The peripheral display shows programmable static and dynamic imagery.

FIG. 8B shows the solar array display system of FIG. 8A, with peripheral display, and also depicting static and/or dynamic imagery shown on the solar array front surface. The array and peripheral display programmable content may be shown independently, or in a coordinated fashion.

FIG. 8C illustrates a side view of the solar array display system shown in FIG. 8B, with the peripheral display shown being able to articulate around a pivot mounted the solar array structure. Such articulation may be advantageous to align the display so as to be readily seen by viewers, independent of solar array orientation. The peripheral display orientation may also be programmed in coordination with the solar array orientation to maximize display content visibility.

FIG. 9 illustrates an example power management method according to embodiments described herein.

FIG. 10 illustrates an example content management method according to embodiments described herein.

### DETAILED DESCRIPTION

### Overview

Solar power generation is a rapidly growing industry, with global capacity exceeding one terawatt. Despite technological advances in efficiency and implementation options, solar power adoption often faces economic challenges that limit wider implementation. For example, traditional solar arrays represent significant capital investments that generate revenue solely through power production, which can result in lengthy return-on-investment timelines that make solar installations financially unattractive in many potential applications.

The present disclosure addresses this economic limitation by creating dual-purpose solar installations that maintain power generation capabilities while simultaneously providing a secondary revenue stream through visual content display. By repurposing the substantial surface area provided by solar arrays as digital signage or advertising space, these systems can generate additional revenue that improves the overall economic viability of solar installations, potentially enabling solar deployment in locations where power generation alone would not justify the investment.

Technical challenges in creating such dual-purpose installations include integrating visual display capabilities with solar power generation without significantly compromising either function, minimizing power generation losses while enabling adequate visual display quality, developing control systems that can appropriately manage both power generation and display functions, and providing installation configurations that maximize both functions.

The solutions described herein address these and other challenges through various embodiments that can be implemented individually or in combination. These embodiments include systems and methods for applying static visual content in a way that minimizes insolation obstruction; integrating transparent or semi-transparent dynamic display technologies with solar panels; incorporating projector systems that can utilize solar array surfaces as display screens; deploying auxiliary displays on solar array infrastructure to avoid direct impact on power generation; and implementing control systems that manage displays (in some cases across multiple arrays) while optimizing for power generation, content visibility, or other goals.

The various static and dynamic display techniques described herein may be combined (e.g., various types of static and/or dynamic displays may be installed or otherwise used at the same location if desired). Whether used individually or in combination, the solutions described herein enable solar installations to serve dual purposes, namely generating clean renewable energy while simultaneously functioning as dynamic or static visual displays. Solar installations can be configured to prioritize various functions depending on external factors such as time of day, weather conditions, power requirements, content display needs, and other factors. This configurability allows operators to make adjustments to enhance economic returns or pursue other goals at different times by adapting system operation to changing conditions and requirements.

The dual-purpose installations described herein can also provide public service or other functions beyond commercial advertising, including displaying emergency notifications such as Amber Alerts, weather warnings, or other public service announcements. These capabilities add further value to the installations and may facilitate permitting processes in various jurisdictions by serving community information needs.

The embodiments described below provide detailed technical implementations of these solutions, covering various configurations of static overlays, dynamic displays, projection systems, pole-mounted displays, control architectures, and the like. Each embodiment addresses specific technical challenges. Each embodiment may be implemented across various installation scenarios, including various settings (e.g., urban vs. rural) and sizes (e.g., from single array installations to large multi-array deployments).

### System Components

The solar array display systems described herein may, in some embodiments, include multiple integrated components that work together to provide both solar power generation capabilities and visual display functionality. An overview of these components and their relationships is provided herein to provide an understanding of an example system architecture.

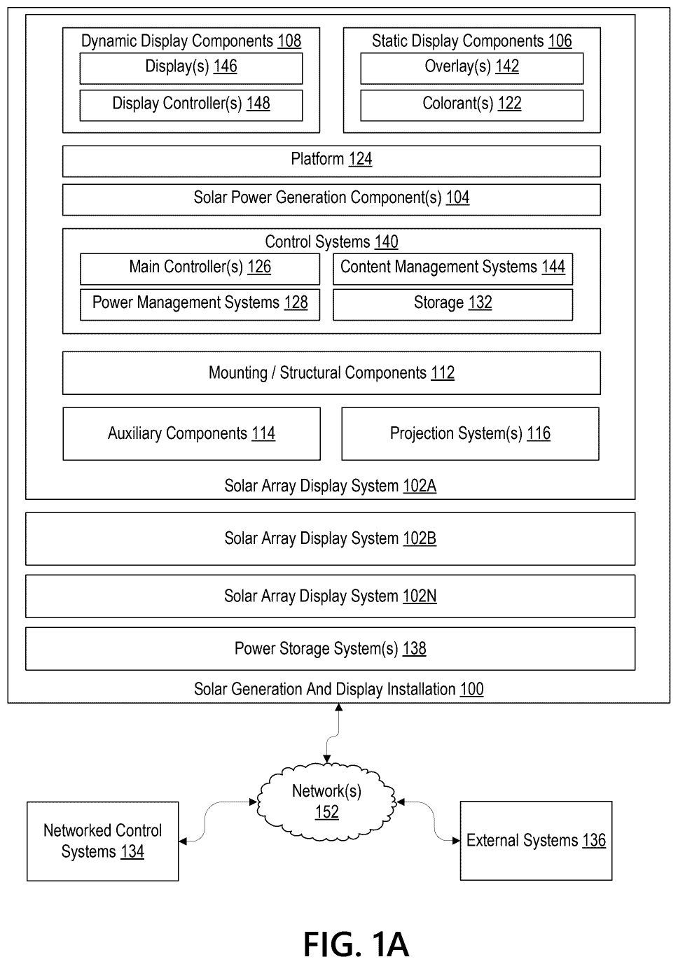

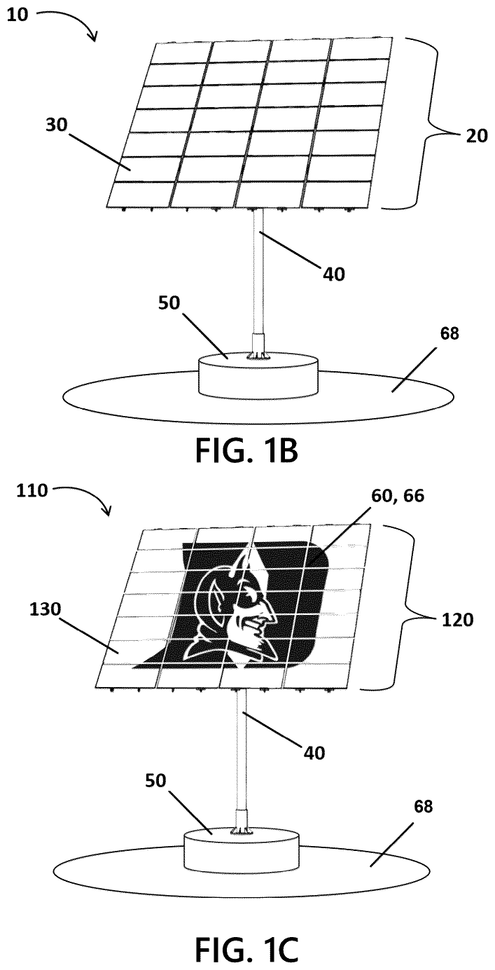

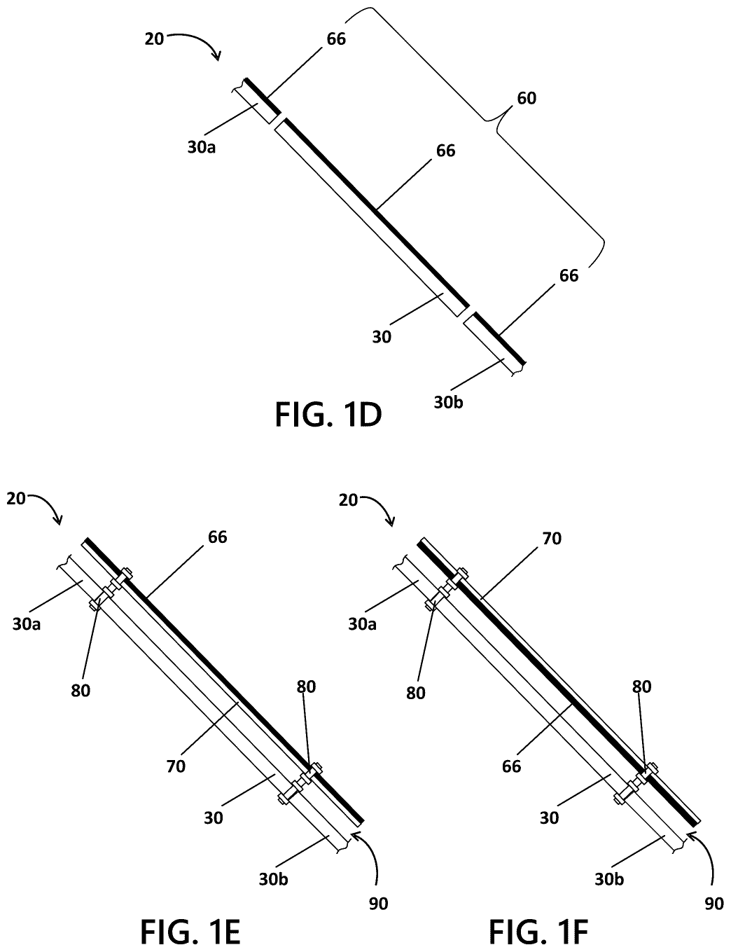

FIG. 1A illustrates an example solar generation and display installation 100 comprising a plurality of solar array display systems 102A-N. FIG. 1A further illustrates an example configuration comprising various sub-components of a solar array display system 102A. The components of the solar array display system 102A may include one or more of solar power generation components 104, static display components 106, dynamic display components 108, a platform 124, control systems 140, mounting and structural components 112, auxiliary components 114, and projection systems 116. These component categories are exemplary and may be selectively implemented and combined in various ways to create different system embodiments as described in more detail throughout this disclosure.

The solar power generation components 104 may be solar modules or panels that convert solar energy into electrical power. Each solar module may include multiple photovoltaic cells in an array (e.g., in a rectangular format), encapsulated between protective layers, and framed with durable materials such as aluminum. The solar modules may incorporate various photovoltaic (PV) technologies including but not limited to monocrystalline silicon, polycrystalline silicon, thin-film technologies (such as amorphous silicon, cadmium telluride, or copper indium gallium selenide), various emerging technologies such as perovskite cells, or any other type of PV module.

The solar modules may be arranged in an array configuration, with multiple modules mounted together on a supporting structure, which may be sized and placed based on site requirements and available space. A supporting structure may include fixed mounts or tracking systems designed to optimize solar exposure by adjusting the orientation of the arrays relative to the sun's position. For the display systems described herein, the solar modules and arrays may be used both to generate electrical power and to provide a surface or substrate for visual displays.

Static display components 106 may include materials and structures that create fixed, non-changing visual content on or in association with the solar arrays. The components 106 may include overlays 142 and colorants 122, which may include pigments, films, membranes, coatings, deposited materials, veneers, and/or thin materials for constructing static overlays that can be applied to the solar modules or to separate transparent platforms 124. The overlay 142 materials may be selected to minimize solar insolation degradation while maximizing visual impact, as described in more detail below. The components 106 may, in some cases, be applied to a substantially transparent platform 124 made of one or more layers placed offset from and substantially parallel to the solar modules, separated by a gap. The platform 124 layer(s) may be formed from suitable materials such as thermoplastics (e.g., polycarbonate or acrylic), high-impact resistant glass, or other suitable substantially transparent materials. The platform 124 may serve multiple purposes, including providing a surface for applying visual content separate from the solar modules, protecting the solar modules from environmental hazards, and facilitating heat dissipation through the gaps between the layers and the solar modules. The platform 124 may be mounted using spacers that maintain appropriate separation between the transparent platforms and the solar modules. The spacers are formed from suitable weather-resistant materials (e.g., stainless steel) and may be designed to rigidly hold the substantially transparent layer(s) in place while minimizing any shadowing effect on the solar modules.

Dynamic display components 108, which may be used together with or instead of static display components 106, may enable programmable, changeable visual content on or in association with the solar arrays. The components 108 may include active display(s) 146, which may be displays that may use various display technologies (including, in some cases, transparent or substantially transparent displays such as transparent LED films, transparent LCD panels, or the like) or any other suitable programmable display. The displays 146 may be mounted to solar modules or associated mounting and structural components 112 in various locations, including (in some cases) transparent platforms 124 offset from the solar modules 104. When the displays 146 are placed in a way that may block solar module insolation, they may use display technologies that are selected to balance visual clarity with light transmission to minimize impact on solar power generation. The dynamic display components 108 may further include display controllers 148 that manage the content shown on the active display(s) 146. The display controllers 148 may be connected to the panels and/or to content sources via wired and/or wireless connection and may receive content inputs, process display signals, and control pixels or segments of the active displays. The display controllers 148 may incorporate (or be in communication with) memory for storing display content, dedicated processor cores for rendering and/or formatting content, and communication interfaces for receiving content updates and commands.

Control systems 140 manage the operation of the solar power generation components 104 and the various dynamic display components 108 (if present). Control systems 140 may include main controllers 126 that coordinate overall system operation. For example, the main controllers 126 may control power management systems 128 that distribute power between generation and display functions, control content management systems 144 that schedule content based on various factors (time of day, power generation needs, etc.) and coordinate content across multiple arrays, communicate with external systems and networks, set priorities, and perform other such functions. Control systems 140 may further include the power management systems 128 that are configured to optimize the balance between power generation and display power consumption. For example, the power management systems 128 may include power monitoring circuits, load balancing systems, algorithms for determining when and how to operate displays 146 based on current power generation, battery storage levels, grid power pricing, and the like. In some cases, the main controllers 126 and the power management systems 128 may be integrated (e.g., power management algorithms may run on the controllers 126) and/or may be separated (e.g., power management hardware may operate separately from the main controllers 126). Control systems 140 may further include content management systems 144, which may include software and hardware systems that provide the interface for programming, scheduling, and managing the visual content displayed on the displays 146. Content management systems 144 may include user interfaces for creating and scheduling content, algorithms for optimizing content based on power generation needs, and network connectivity for remote management. Like the power management systems 128, the main controllers 126 and the content management systems 144 may be integrated or separated.

Control systems 140 may communicate with each other and other components of the system using communication interfaces that enable data exchange between system components and/or with external networks. The communication interfaces may include wired connections (e.g., Ethernet) and/or wireless technologies (e.g., Wi-Fi, Bluetooth, etc.). Control systems 140 may further include user interfaces that enable human interaction with the system for content management, system monitoring, manual control, etc. The user interfaces may include local control panels (e.g., for maintenance personnel, and/or serving as “self-serve” kiosks for general public usage), web-based dashboards, mobile applications, and the like.

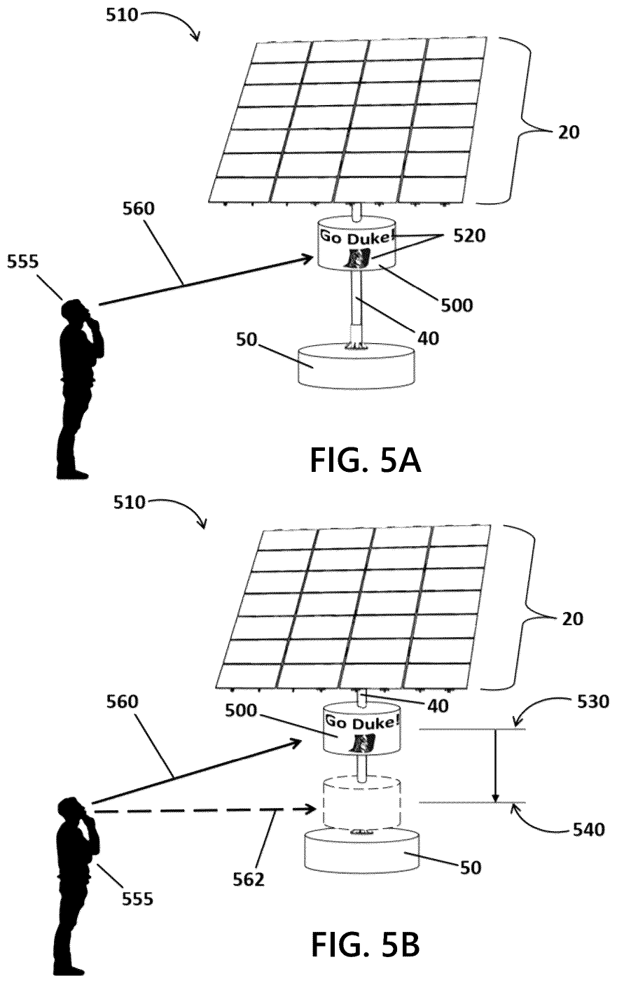

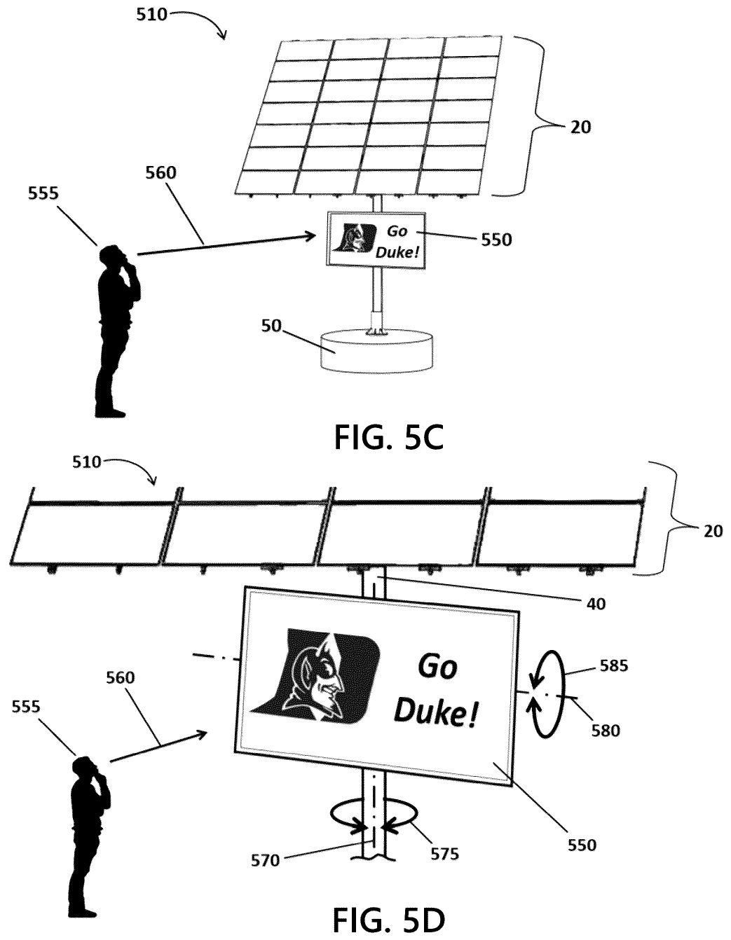

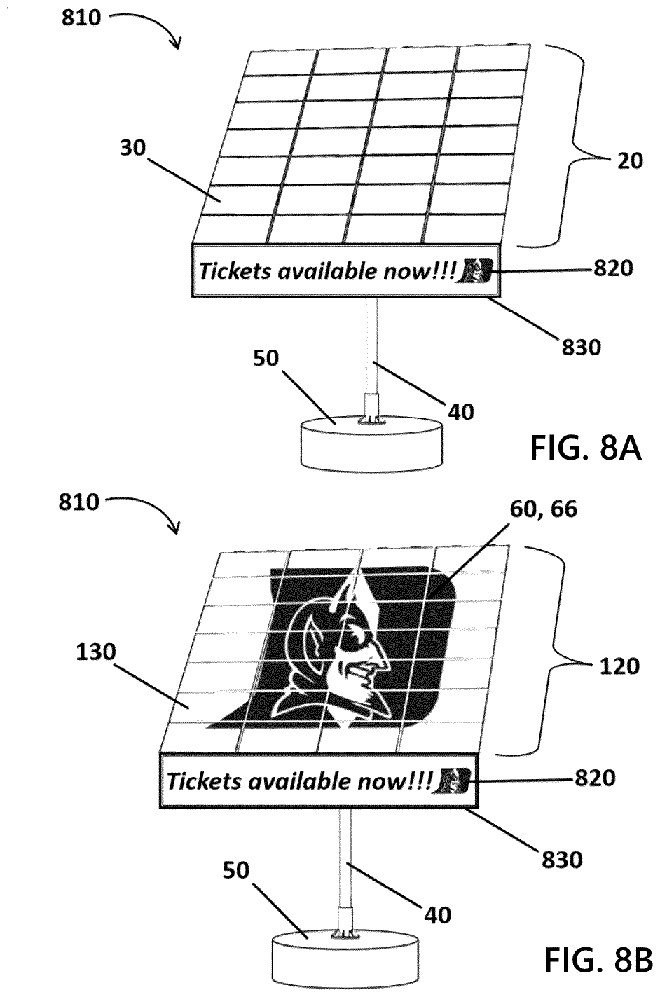

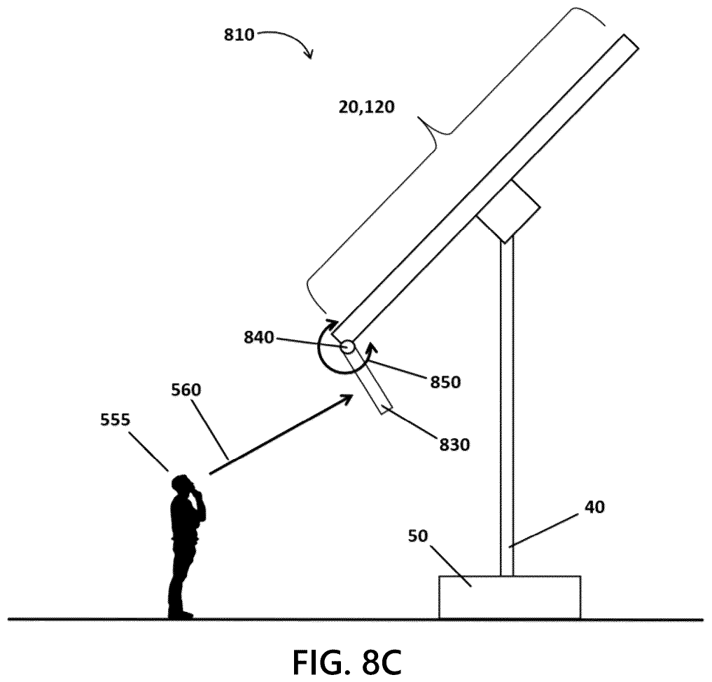

Mounting and structural components 112 provide physical support for the solar arrays and associated displays 146, as well as other related components. These components 112 may include support poles, which are vertical structural elements that support the solar arrays and may (in some cases) serve as mounting locations for peripheral displays (described in more detail below). Support poles are typically constructed from steel or other durable structural materials and are designed to withstand environmental forces such as wind and snow loads. It should be noted that mounts other than support poles are within the scope of the disclosure. Mounting and structural components 112 may further include base foundations that anchor the support poles (or other mounting hardware) to the ground or other mounting surfaces. Base foundations may be constructed using concrete (e.g., reinforced poured concrete) to provide stable support for the system. Mounting and structural components 112 may further include array mounting hardware to connect the solar modules to the support structure. The array mounting hardware may include brackets, rails, clamps, fasteners, and the like, configured to securely hold the solar modules while accommodating thermal expansion and contraction. Mounting and structural components 112 may also include pole-mounted display structures that support displays 146 mounted to the support poles (e.g., as shown in FIGS. 5A-5D). These structures may include fixed or movable display tubes that wrap around the pole, panel screen assemblies mounted to the pole with articulating brackets, and the like. The mounting and structural components 112 may also include peripheral display mounts that attach displays 146 to the edges or other non-power-generating portions of the solar array structure (e.g., as shown in FIGS. 8A-8C). The peripheral display mounts may include articulating mechanisms to adjust the viewing angle independently from the solar array orientation.

Auxiliary components 114 may include audio systems, such as speakers and associated audio equipment that may be integrated with the displays 146 to provide synchronized audio content. Audio systems may include speakers positioned on the array, pole, base, and/or surrounding buildings and/or terrain, and may support various audio formats and configurations. Auxiliary components 114 may further include lighting systems, such as additional lighting that may be incorporated into the solar array structure to illuminate the displays, enhance visibility in low-light conditions, provide decorative effects, or the like. Auxiliary components 114 may further include weather protection systems that protect the display and electronic components from environmental hazards. Auxiliary components 114 may further include cameras and sensors that may be used to capture environmental data for various reasons, including displaying data on the active displays 146 or as inputs to algorithms that adjust display content. As one example, cameras may capture background scenes that can be used for display on the front of the array to reduce the visual impact of a solar array as described in more detail below.

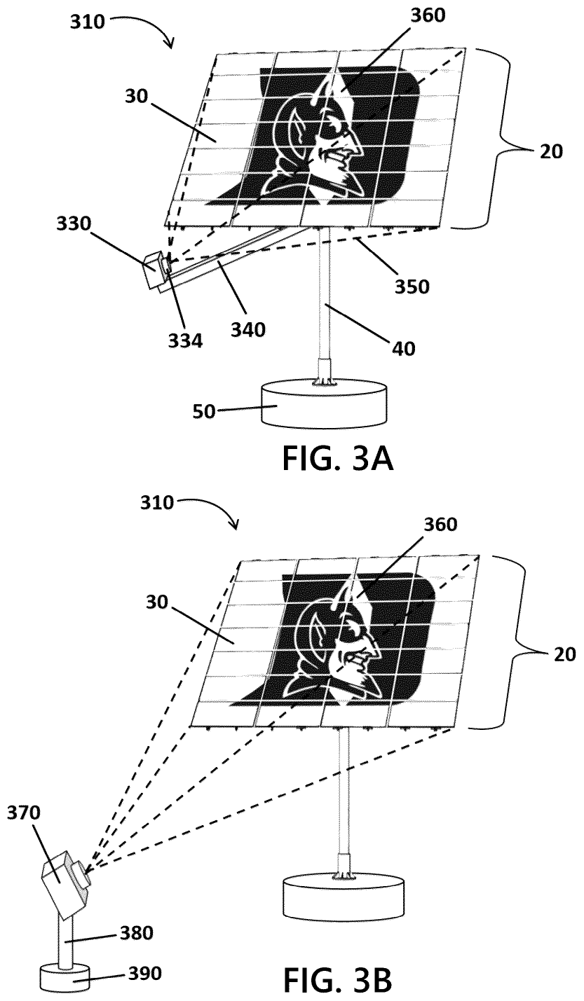

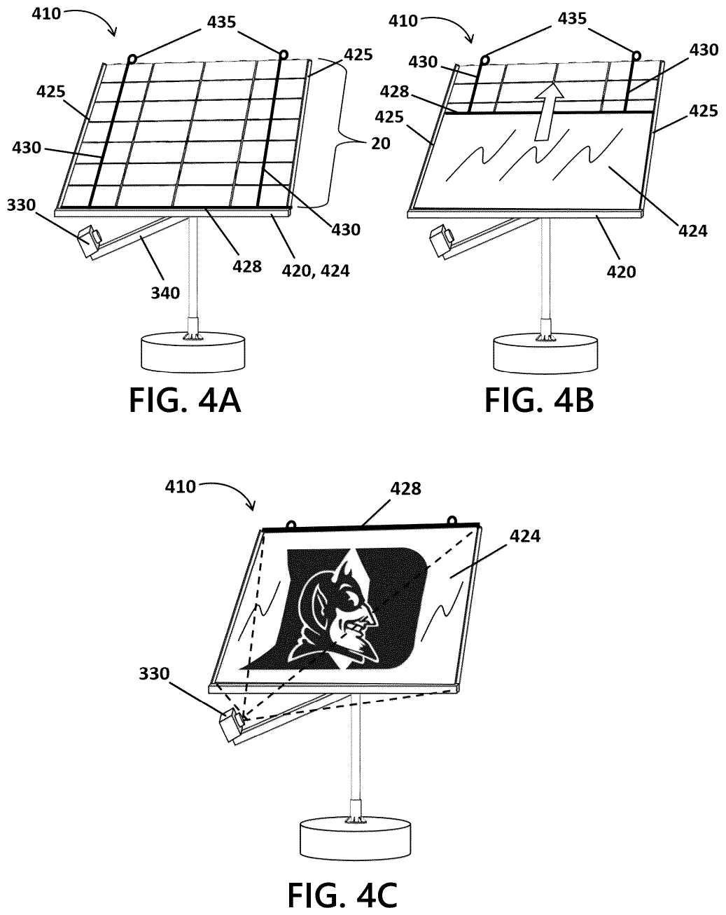

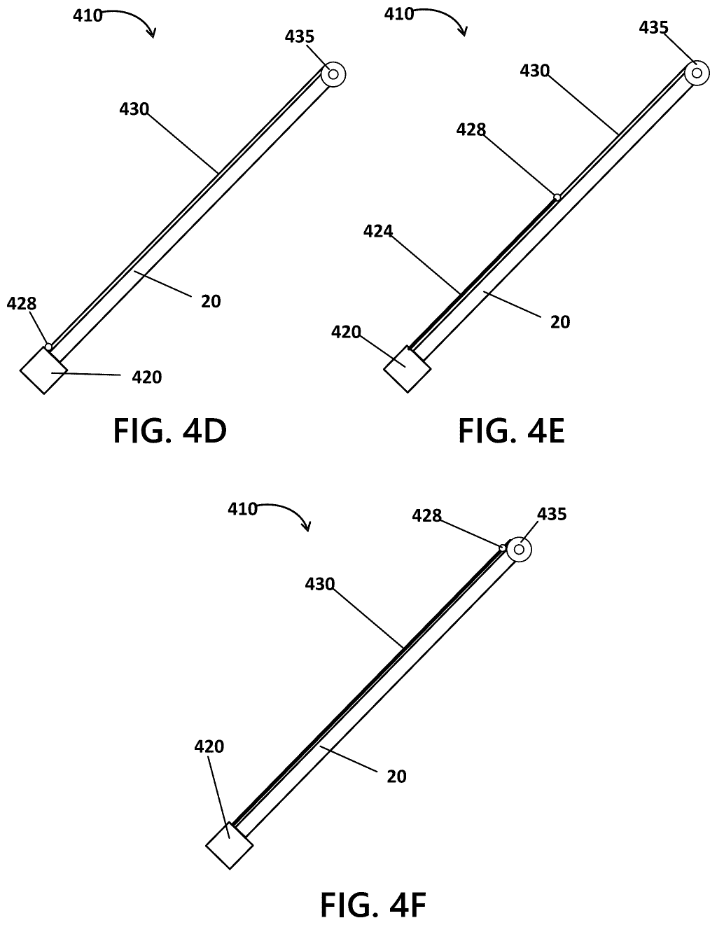

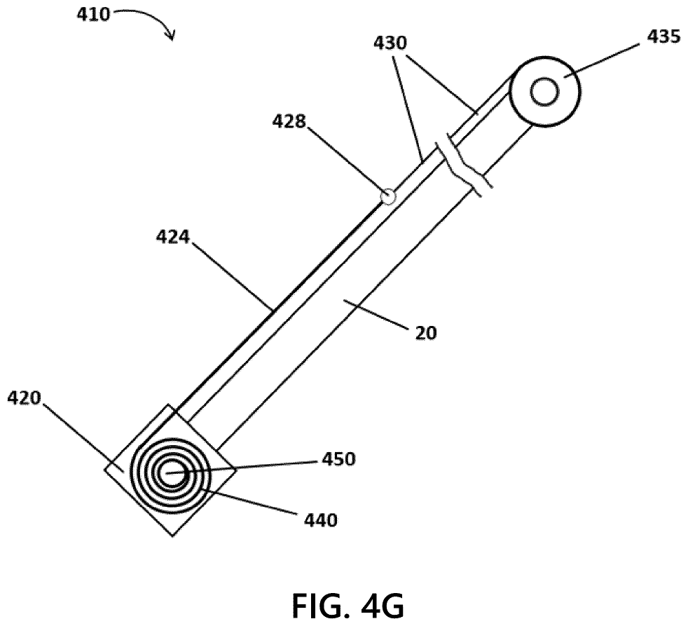

Projection systems 116 use light sources to display visual content on solar arrays or dedicated screens. The projection systems 116 may include optical projectors that project visual content onto a surface. The optical projectors may be proximal (e.g., mounted directly to the solar array structure as shown in FIG. 3A) or remote (e.g., positioned separately from the array as shown in FIG. 3B). Optical projectors may use various display technologies including DLP (Digital Light Processing), LCD (Liquid Crystal Display), LCOS (Liquid Crystal on Silicon), LED, laser, etc., and may feature different throw distances (standard, short throw, ultra-short throw, long throw, etc.) depending on specific installation requirements. Projection systems 116 may further include projector mounting brackets used to secure proximal projectors to the solar array structure. The projector mounting brackets may position the projector at an optimal angle and distance for projecting onto the intended surface while also maintaining stability in various weather conditions. Projection systems 116 may further include deployable screens, which are movable reflective surfaces that can be extended from a stowed position to serve as projection surfaces in some conditions (e.g., at night). As shown in FIGS. 4A-4G, deployable screens may be stored in a screen bin when not in use and extended across the solar array when needed for projection purposes. The screens may be made from appropriate materials that provide high reflectivity for projected content. In some cases, the screens may be constructed to allow some light transmission for use during daylight hours. Projection systems 116 may further include screen deployment mechanisms, which are mechanical systems that control the extension and retraction of deployable screens. As illustrated in FIG. 4G, these mechanisms may include screen pivots, motors, cables, screen bars, and/or tensioning systems to ensure proper deployment and flatness of the screen surface.

An installation 100 may include a plurality of solar array display systems 102A-N, which may communicate with each other using various networking technologies described elsewhere herein. In embodiments, the installation 100 may further include power storage systems 138, which may include batteries and associated components, such as charging components, battery power systems, sensors, and the like.

As shown in FIG. 1A, the solar generation and display installation 100 may connect to one or more networked control systems 134, which may be used instead of or in addition to the array-specific control systems 140. For example, any of the control system components (e.g., main controllers 126, power management systems 128, content management systems 144, storage 132) may be communicate with and control one or more of the solar array display systems 102A-N via one or more networks 152, which may include local networks, wide area networks, the Internet, or any other networks. In these embodiments, the control systems 134 may be centralized network components that coordinate among and control a plurality of solar array display systems 102. The control systems 134 may be physically co-located with the solar generation and display installation 100 or located remotely from the installation 100.

The various solar generation and display installations 100 may further integrate with one or more third party systems 136, which may include building management systems, smart city infrastructure, emergency notification systems, energy grid systems, advertising networks, electric vehicle charging stations, security systems (as described in more detail below), and/or other systems.

Based on the above components, several example configurations are provided below. It should be understood that the following configurations may be combined in various ways.

### Static Display Configurations

In some embodiments, a solar array display system 102 may include a static display using pigments or other colorants 122 to form an image that may be superimposed over one or more solar modules in an array. The module(s) and associated pigments in superposition may, solely or in aggregate, combine to form visual text, images, and/or icons displayed across the full array. This dual functionality increases the revenue-generating potential of solar installations by transforming otherwise visually inactive square footage into active advertising space or informational displays.

Visual image colorant(s) 122 may be applied directly to individual solar modules and/or on one or more overlay platforms 124 that are substantially transparent layers placed over one or more solar modules. Direct application to the solar module surface may be the simplest method and may reduce the use of additional materials. In this context, the pigments may be applied directly to the solar module or platform 124, and/or may be applied to overlays 142 that may be affixed to the solar module or platform 124. Direct application techniques may include using adhesive materials to apply pigmented overlays via wet or dry methods, spray application of translucent pigments for larger areas or gradients (which can use masking techniques to create defined patterns), and the like.

In some cases, overlay platforms 124 may be used to hold colorants 122 and/or overlays 142 to create a static display. Depending on usage, pigments may be deposited on the inside or outside layers of the platform 124. An internal layer placement may prove advantageous, for example, to shield pigments from environmental hazards such as incident UV radiation, abrasive dust, ice and snow accumulation, or hail. The platform layers may also serve a dual role as protective “shielding” for the underlying solar modules, helping reduce or avoid hail damage effects, for example. Alternatively, an exterior layer placement may beneficially allow for easier changing of the static visual content (e.g., if the pigments are removably attached to the solar module(s) and/or platform(s) 124). The platform 124 may also provide the benefit of separating the visual content from the solar array to prevent heat buildup, thereby reducing the chance of overheating. In some cases, pigment deposition (either in direct application or platform contexts) may be configured to balance insolation degradation with visual impact of the display. Additionally or alternatively, the pigment deposition may be selected to reduce potential overheating or other negative effects of high insolation while still maintaining high power generation. The following considerations may be used to choose and configure specific materials for a static display, depending on context and desired results for a particular installation.

Pigments or other colorant materials may be selected to balance light transmission for power generation with display visibility. In some cases, techniques for applying pigments such as silicon deposition may be used that block a narrow single-color light frequency band (or a narrow range of bands), enabling the module covering to appear opaque, while allowing other components of the visible light spectrum to pass largely unattenuated. In embodiments, the pigment may be a color that blocks only light of a specific wavelength (or band of wavelengths) that is chosen to optimize power generation based on the spectral response of the solar array (e.g., which may vary by manufacturer, technology, etc.). For example, some modules may absorb more energy from higher frequencies (e.g., blue light), and therefore the selected pigment may be a lower frequency color such as red.

Pigments or other colorants 122 may be applied to overlays 142 that may then be applied to the solar panel or platform 124. These overlays 142 may include thin-film overlays embedded with pigments or other colorants, thus minimizing light blockage while maintaining visual clarity. Materials such as polyethylene terephthalate (PET), fluoropolymers, and silicone-based films may be used to provide transparency with various degrees of cost, weather resistance, and durability. Additionally or alternatively, an overlay 142 may be made from perforated vinyl and/or polymers containing holes that maintain the appearance of a solid image from a distance while allowing some light to pass through. Additionally or alternatively, the static overlay may include films containing transparent colorants that allow significant light transmission while displaying color. Transparent color films may be effective when solar modules have greater sensitivity to wavelengths outside the visible spectrum. As another option, the static overlay may be made from dichroic films, which are optical films that appear to change color depending on viewing angle while maintaining significant transparency.

Pigments may be deposited (directly on a solar module and/or on an overlay) in patterns that appear opaque but allow light through regular non-pigmented apertures (such as circles and hexagons) increasing the ratio of transparent to opaque effective area. Small apertures (e.g., in an overlay 142) may also provide a “pinhole camera” effect focusing light on a wider panel module area. In embodiments, the apertures may be sized and spaced to balance power generation against visual impact, which may involve selecting a particular shape of aperture (e.g., round, hexagonal, slit, etc.) and a particular size (which may be a function of the average wavelength of visible light or another relevant wavelength for power generation). Moreover, the number and/or size of apertures may be selected or adjusted based on the resultant visibility of the visual content. Optimization parameters for micro-aperture patterns may include aperture size, which affects visual opacity at a distance while allowing light transmission; aperture density based on power generation and visual requirements; and distribution pattern, where apertures may be arranged in regular geometric patterns (e.g., grid, hexagonal) or pseudo-random patterns to avoid moiré effects. For the pinhole camera effect, small aperture diameters (e.g., from 0.5 mm to 3 mm) may optimize the effect, depending on the distance between the pigment layer and the solar cells, the desired focus area, and the wavelengths of light being considered. However, it should be noted that very large apertures may be used to provide greater insolation and may still provide visible images, especially when viewed from a distance.

Pigments or other colorants may be partially transparent, allowing some fraction of light through while retaining enough opaqueness to form a legible array image. Opacity may be optimized using semi-transparent pigment formulations with specific transparency levels. In some cases, multiple thin layers with different optical properties may be applied to achieve complex visual effects while maintaining overall light transmission. For example, a base layer with higher transparency may be overlaid with more opaque accent layers in specific areas. Additionally, the pigments may be applied using semi-transparent printing techniques such as halftone patterns, with varying densities of pigmented (either semi-transparent or opaque) regions to create the illusion of continuous tone images while maintaining areas of transparency. These patterns can be optimized by using varying dot sizes, densities, using color separation for multi-color designs, and using gradient opacity implementations. In embodiments, the static images may be constructed of many separated regions of pigmented (cither semi-transparent or opaque) material, with no overlay 142 material in between the pigmented material.

In some cases, static overlays may be applied in a way that simply limits the number of solar modules that have applied pigment, for example by using a smaller image area that covers a reduced percentage of total array surface area. For example, visual content may be concentrated on specific solar modules within the array based on their contribution to overall power generation, with priority given to modules that receive less direct sunlight due to array configuration or shading.

In some cases, static visual content may be mounted on a reverse side of a solar array (e.g., on a back side that may normally face away from the sun). In these embodiments, the static visual content may be attached directly to the back side of the solar array or to a mounting panel mounted adjacent to the back side of the solar array (e.g., where the mounting panel may be constructed as described above). This arrangement may be particularly beneficial when viewers are likely to be underneath the solar arrays (e.g., because the solar arrays are mounted over a parking lot or similar area) or otherwise in visual range of the reverse side of the solar array based on a height and/or visual inclination of the solar array at a particular installation. In these embodiments, mounting static visual content may lead to less degradation of power production, although some solar arrays may still generate power (e.g., about 20% of total power) based on light received via the reverse side of the solar array. Thus, to further minimize the degradation of power generation, the techniques described above may be used on the static visual content even when the static visual content is arranged on the back of the solar array. It should be noted that the dynamic displays that are further described below may also be mounted on the back side of the solar array. Additionally or alternatively, a solar array may use any of the techniques described herein to display static or dynamic content on both the front and back sides of the solar arrays if desired.

Static visual content applied to solar arrays may need to withstand harsh environmental conditions. Pigments and substrate materials may be selected to resist degradation from prolonged exposure to ultraviolet radiation, such as UV-stabilized polymers, ceramics, and inorganic pigments. Materials may also be selected to withstand repeated thermal expansion and contraction as temperatures fluctuate between day and night and across seasons, which may be beneficial for direct applications to solar modules, as differential expansion could cause delamination or other damage. In wet environments, water-resistant and vapor-permeable materials may be selected to prevent moisture accumulation between layers. In environments with airborne particulates (e.g., sand, dust), materials that resist abrasion may be selected to avoid degradation of visual appearance over time (e.g., depending on how long the static overlay is intended to last). In some cases, employing hard-coated surfaces or sacrificial top layers can extend service life. Additionally, materials may need to withstand exposure to atmospheric pollutants, cleaning agents, and/or other chemicals that may be encountered at a particular installation. For these reasons, static overlay materials and construction may vary depending on installation.

### Dynamic and Programmable Display Configurations

In some cases, in addition to or as an alternative to the display of static content, a solar panel array may display dynamic imagery, such as by showing successive static images and/or full video presentation via one or more displays 146. In these embodiments, the visual content may be changed over time, randomly and/or on a schedule, etc., thereby allowing for a greater variety of content. For example, the visual content for displays 146 may include video and/or image advertisements, public service announcements such as Amber or Silver Alerts, weather alerts, and the like (which may include associated photos and/or videos such as a license plate photo), and/or any other visual content which may be useful for any purpose.

In these embodiments, a display 146 (such as LCD format) may be superimposed over one or more solar panel modules. Additionally or alternatively, a display may be mounted elsewhere on the solar array, such as on a back side of the solar array, as a pole-mounted display as described more below, and/or in another location. As for the static image method, the display may be mounted flush to modules, or suspended structurally with a gap between the module and screen. Such a gap may improve thermodynamic convection, allowing better cooling of both the solar module and display screen structure.

When displays 146 are arranged in a location that may (at least partially) block solar module insolation, display technologies may be selected to create an optimal balance between visibility and solar energy transmission, based on installation. Such display technologies may include transparent LCD (Liquid Crystal Display), transparent LED (Light Emitting Diode), OLED (Organic Light Emitting Diode), or other technologies that are least semi-transparent. Transparent LCD displays may provide 70-85% light transmission when inactive, with active pixels reducing transmission based on display content and brightness settings. When mounting on a solar array, extra transparent materials (e.g., low-iron glass) may be used to maximize light transmission to the solar array. Transparent LED displays use micro-LEDs spaced in patterns that allow substantial light transmission through non-illuminated areas. These displays can achieve 60-80% transparency depending on pixel density. In some embodiments, LEDs may be spaced based on the spectral response characteristics of the underlying solar module. As another example, OLED displays may have transparency rates of 40-70% depending on configuration.

When selecting display technologies for a particular installation (whether transparent or not), various factors including environmental conditions, viewing requirements, and power generation priorities may affect choice of display technology. For example, for installations in high-ambient-light environments, high-brightness LED displays may be beneficial despite higher power consumption, while installations prioritizing power generation efficiency may use higher-transparency and/or lower-power display technologies such as LCD.

Displays 146 may be integrated with solar modules via direct surface mounting, mounting on an offset platform 124, and/or attaching elsewhere to the solar module or mounting hardware. In embodiments, rollable display devices (e.g., flexible OLEDs) may be stowed when not in use and deployed when display is desired (e.g., when power is not being generated or during operational modes that do not prioritize power generation). In these embodiments, the display devices may be stowed in a similar manner as the rollable projector screens described below for FIGS. 4A-G.

In some installations, a display 146 may be attached directly to the front or rear surface of existing solar modules (e.g., using optical adhesives). This method provides minimal separation between the display and module, thereby maximizing optical coupling and minimizing parallax effects. An optical adhesive may be UV-stable, have a refractive index matched to both the display substrate and module front surface, and maintain flexibility across a desired operating temperature range. Suitable adhesives may include silicone-based optical gels. The direct mounting method may require electrical connections to the necessary display drivers and control circuitry (e.g., in edge-mounted junction boxes). Power and signal conductors may be routed along the module frame, through channels incorporated into the frame structure, or in another suitable manner.

In offset platform mounting installations, the display 146 may be mounted to a transparent platform 124 separated from the solar module by a defined gap. As described above, a platform provides advantages such as improved thermal management through convective air flow between the display and module, reduced mechanical stress transfer between components, and easier maintenance access to either component. The offset platform 124 may be constructed using glass (e.g., tempered low-iron glass), UV-stabilized polycarbonate, or another suitable material with thickness selected depending on the size and required structural strength. Platform spacers may be constructed from corrosion-resistant materials such as stainless steel or anodized aluminum and may incorporate vibration-damping elements to reduce mechanical fatigue during wind events.

In the offset platform configuration, display materials may be attached to the external surface or internal surface of the platform 124. As described above, external attachment provides easier access for maintenance but requires enhanced environmental protection, while internal attachment offers better protection from environmental factors but complicates repair procedures.

Some or all of the solar module(s) may be equipped with a corresponding display 146 that may be individually and/or collectively programmable such that content on each display may be combined and choreographed in a way that makes the overall array act and appear like a single cohesive large- or jumbo-television screen or screens. Display “programming” may be performed by one or more control systems 140 that may be mounted proximally to the solar array or at some distance. The control systems 140 may communicate with the display(s) 146 (e.g., specifically with display controllers 148) via wired (e.g., Ethernet) or wireless (e.g., Wi-Fi or Bluetooth) networking protocols. Additionally or alternatively, the control systems 140 may communicate with the displays via various networks, including local networks, mobile cellular networks, the Internet, etc.

Display controllers 148 control the interface between computing resources (e.g., control systems 140) and physical display elements, for example by converting video signals into the format required by the specific display technology employed. Controller 148 hardware may include processors, including (in some cases) dedicated graphics processing units (GPUs), which may support various input formats including HDMI, DisplayPort, and/or SDI digital video inputs supporting resolutions matching the display configuration, technology-specific drivers (e.g., for LCD, LED, or OLED displays 146), etc. The controller 148 hardware may operate within various temperature ranges and may typically receive 12-48V DC input power, with power consumption depending on processing requirements. For wired control configurations, display conduits may connect the controller 148 to the display. These conduits may also include power conductors sized appropriately for the display power requirements along with shielded data connections.

### Control Systems

The main controllers 126 may be responsible for balancing multiple objectives that may be in competition. For example, the main controllers 126 may, at any given time, prioritize power generation or dynamic display visibility (e.g., via adjusting the brightness of a display, reorienting the solar module and/or display components of the solar module) in various degrees to maximize one or more of revenue via power generation, revenue via display of advertising or other paid materials, display of important information, or other priorities.

In some cases, the main controllers 126 may not necessarily have to balance one goal versus another; for example, during low light conditions, power generation may be unavailable as a priority to maximize or balance against other priorities. However, in many cases, the main controller may need to balance power generation against other display-related priorities.

The main controller 126 may use various operational strategies to balance competing priorities of power generation and display optimization. These strategies may be user-configurable and/or adaptively selected based on current conditions, system requirements, and/or predetermined schedules. In some cases, these strategies may correspond to specific operating modes.

In a revenue optimization mode, the main controller 126 may periodically or continuously (e.g., in real-time) evaluate the potential revenue from power generation versus advertising display at any given moment. For example, if electricity prices and light levels are high, the controller 126 may increase power generation by reducing display 146 opacity or brightness, orienting the solar modules to maximize insolation, etc. Conversely, during times when advertising rates may command premium prices (e.g., high-traffic periods), the controller 126 may prioritize display visibility at the expense of power generation.

In an information priority mode, the controller 126 may override other considerations (e.g., revenue) to ensure important information is displayed with maximum visibility. For example, the controller 126 may optimize for information display in response to emergency alerts, public service announcements, or other high-priority communications. Additionally or alternatively, the controller 126 may optimize for displaying important information to customers of a nearby facility (e.g., pricing information) at the expense of power generation. In some cases, the controller 126 may temporarily set an information priority mode, including selecting a duration and/or display parameters, based on the type and/or urgency of the information being displayed.

In a power generation priority mode, the controller 126 may maximize energy production regardless of potential advertising revenue loss. For example, the controller 126 may use this priority mode during grid stress events, when battery reserves fall below minimum thresholds, during scheduled maintenance periods requiring power reserves, and/or the like. In this mode, display functionality may be minimized or disabled entirely.

Additionally or alternatively, instead of using discrete operating modes, the controller 126 may set priorities in other ways. For example, the controller 126 may require an installation 100 and/or solar array display system 102 to generate at least a minimum threshold amount of power, or may require a power storage system 138 to store at least a minimum amount of power, but may prioritize content display over generating and/or storing additional power above the minimum threshold(s).

In embodiments, the controller 126 may use a schedule that specifies different operational strategies for different time periods and/or conditions for entering different strategies. The schedule may be configured via a user interface in communication with the controller 126. For example, the schedule may allow system operators to plan for known events, such as daily traffic patterns, seasonal changes in sunlight, displaying information related to special community events, and the like. The schedule may further specify conditions for interrupting scheduled operations, such as receipt of emergency information, minimum battery storage thresholds, and the like.

The main controller 126 may receive data from multiple data sources for decision-making related to the selection of operational mode or strategy. These data sources may include real-time measurements (e.g., current solar irradiance, ambient light levels, current array direction(s), power generation rates, battery charge status), external data feeds (e.g., weather forecasts, electricity market spot prices, traffic patterns, emergency alerts), or other sources of current data. The main controller 126 may also have access to historical data for use in predictive models.

In embodiments, the controller 126 may execute predictive models, including machine learning algorithms as described further below, to anticipate changing conditions and proactively adjust system parameters accordingly. For example, weather prediction models may allow the controller 126 to anticipate cloud cover and preemptively adjust display brightness or content scheduling hours in advance, store more power in power storage systems 138 in anticipation of reduced power generation capability, etc.

The controller 126 may interface with the power management system 128 (which may control solar array positioning such one- or two-axis tracking, power generation, display power consumption, etc.) and the content management system 144 (which may select and schedule appropriate content for display based on current conditions and/or revenue objectives) to achieve a current goal or set of goals.

### Power Management

Active/dynamic displays 146 require power and may draw that power from the solar modules, thus reducing power available for revenue generation or other purposes. The dynamic and/or static displays described above may also drive revenue generation (e.g., when used for advertising purposes) but may also reduce insolation of the solar arrays, depending on placement with respect to the solar modules. These relationships create several variables that may be controlled for power management purposes. For example, where the display system both reduces the power generation capacity (by blocking some incident light) and consumes power for its operation, effective power management strategies balance these factors to maintain system viability. Moreover, in some cases and/or at some times, power generation may not be a top priority, for example because it takes a second place to revenue generation via the displays. The power management system 128 thereby differs from typical power controllers for solar modules, which typically seek to maximize power generation at all times, and typically only manage power generation instead of power consumption.

In dynamic display embodiments, the power management system 128 may manage the power consumption of the display, which may vary based on the display technology employed, selected display brightness, and/or content being displayed. Some types of displays (e.g., transparent LED displays) may consume more power than other displays (e.g., LCD or OLED). Depending on display size and type, the display power consumption may represent a small or a fairly significant part of the power generation capacity of a typical solar module under insolated conditions.

Power management strategies for displays 146 may include content-aware brightness control. For example, the power management system 128 may control displays 146 to adjust display brightness based on ambient light conditions. In some cases, the power management system may increase display brightness not only based on ambient light, but on one or more content characteristics. For example, content may require minimum brightness, such as to maintain specific contrast ratios. Additionally or alternatively, the power management system may increase brightness for high priority content (e.g., high revenue generation content), thus increasing power consumption. These and other factors are described in more detail below with regard to the content management system, which may be in communication with the power management system to adjust content in accordance with power management strategies.

In some embodiments, the power management system 128 may reduce brightness on a per-pixel basis and/or deactivate certain pixels to reduce display power consumption (e.g., for display technologies that allow for individual pixel control). In these embodiments, the power management system may, for example, selectively reduce the brightness of a subset of pixels which may be randomly selected, selected based on color or brightness value (e.g., capping maximum pixel brightness), selected based on location within a display, or otherwise selected in some way. Similarly, the power management system may, in coordination with the content management system described elsewhere herein, optimize pixel activation by selecting specific content based on the content having display patterns that minimize the number of active pixels or reduce power-intensive color combinations.

The power management system 128 may also, alone or in coordination with the controller 126 and/or content management system 144, temporally optimize the use of displays 146 to maximize array efficiency and revenue generation. For example, the power management system may use higher-power display settings during periods when solar generation exceeds demand and/or when electricity market value is relatively low. As a specific example, during peak sunlight hours when the solar array produces maximum output, the power management system may receive a signal from the controller 126 indicating excess power generation and/or low revenue from power generation. Upon receiving this signal, the power management system may respond by adjusting the display to operate at increased or full brightness. The content management system 144 (described more below) may also schedule higher priority content and/or more power-intensive content during the periods of excess power generation. Conversely, during night, early morning, or evening hours when power generation capacity is non-existent or limited, and electricity market prices may be elevated due to grid demand, the power management system may receive a signal from the controller 126 indicating that display power should be reduced. The power management system may then respond by reducing display brightness or otherwise reducing power consumption. Again, the content management system may similarly schedule lower-power-consumption or lower revenue content during such times.

In some cases, the controller 126 may also predict conditions to optimize the operation of the power management system 128 based on machine learning techniques. For example, the controller 126 may train and/or execute a supervised learning model trained on historical data sets comprising weather forecast data, actual weather measurements, solar irradiance, power generation data, energy pricing information, and/or battery storage metrics collected over extended periods. The model may be trained for general use (e.g., a foundation model trained on data collected over a large number of solar installations) and then fine-tuned using installation-specific data. Additionally or alternatively, the model may be trained only on installation-specific data. In embodiments, the model may be trained to predict target variables (e.g., categorical indications of whether battery charge levels remain above one or more thresholds, continuous indications of battery storage capacity, expected power generation capacity for upcoming time periods, etc.). During training, the model may learn patterns between input features (which may indicate time of day, season, weather forecasts, historical performance, etc.) and the target variables, enabling it to make increasingly accurate predictions as more operational data is collected.

The predictive capability of such a model allows the system to implement proactive power management strategies. For example, if the model predicts an upcoming period of reduced solar generation due to forecasted cloud cover, resulting in battery levels approaching minimum thresholds, the power management system 128 may preemptively reduce display power consumption, temporarily switch to more transparent display modes, or take other relevant steps to increase power generation and/or reduce power consumption.

The machine learning model may be implemented using various architectures suitable for time-series prediction, including recurrent neural networks (RNNs), long short-term memory networks (LSTMs), transformer models, or ensemble methods that combine multiple predictive algorithms. The model may be trained by the controller 126, which may feed training data into the model to generate predictions, compare the generated predictions to the actual target data from the training data set, compute a loss based on the difference between the generated prediction and the actual target data, and update the weights of the model using backpropagation algorithms (e.g., gradient descent). The controller 126 may periodically retrain the model with new operational data to maintain prediction accuracy over time and adapt to seasonal variations or gradual changes in system performance characteristics. The predictions generated by the model may be used by the power management system to control power management decisions as well as by the content management system to control content scheduling decisions, described in more detail below.

In addition to temporal considerations, the power management system 128 may use spatial optimization techniques that may position visual content in particular portions of a display surface to maximize overall system efficiency. For example, when a solar array is at least partially obstructed by a display, the power management system 128 may position high-brightness and/or power-intensive visual elements on portions of the solar array that correspond to underlying solar cells with lower efficiency and/or partial shading. For example, if a particular section of the solar array is partially shaded by nearby structures during certain hours, the power management system 128 may (alone or in coordination with the content management system) reposition content that does not require the entire display screen such that the brightest or highest-contrast elements of the displayed content cover the shaded solar cells. Similarly, if certain modules within the array have degraded efficiency (e.g., due to aging or other factors), the power management system may preferentially use the display area above those modules for power-intensive content.

In these embodiments, the controller 126 may implement monitoring functions to track per-module performance across a solar array. The controller 126 may transmit indications of which solar modules are less performant in general or at specific times to the power management system. The power management system may then use these indications to dynamically adjust content positioning on a display to maximize power generation.

In embodiments, the power management system 128 may be responsible for positioning the solar arrays with respect to the sun. In some cases (e.g., if a display is pole-mounted and independently articulates as described in more detail below), the power management system may position the solar arrays to maximize power generation. However, in some cases, the power management system may control the positioning in a way that optimizes for other objectives. For example, the content management system 144 may indicate that the display content should be positioned with respect to a specific angle/direction or set of angles/directions. In these embodiments, the power management system may attempt to maximize power only as a secondary goal. For example, if a display needs to be pointed in a particular direction, the power management system may only be allowed to deviate from the specified direction by a certain threshold (e.g., 5-10°). Thus, the power management system may have a narrow “window” (or potentially set of windows if the content management system specifies multiple viable directions) within which the solar arrays may be adjusted to maximize their power generation. The windows may be specified in terms of horizontal/azimuth angle and/or in terms of vertical/elevation angle (e.g., for dual axis tracking systems), and the amount of deviation may vary between the horizontal/azimuth and the vertical/elevation adjustment.

In implementations featuring multiple display types or configurations, such as hybrids of the embodiments described below, the power management system may selectively activate the most power-efficient display option based on current conditions. For example, during peak sun hours, the power management system may activate only peripheral displays 146 that minimally impact solar generation, while larger dynamic displays 146 that may interfere with power generation can be activated during early morning, late afternoon, or nighttime hours when power generation loss is less of a factor.

The power management system 128 may operate in various modes that balance power generation and display functions according to varying conditions and priorities, as instructed by the main controller 126. These modes may include a maximum generation mode where displays 146 are minimized or disabled to prioritize power output, a balanced operation mode with displays 146 operating at various power consumption rates (which may be increased or decreased to prioritize one or other) to maintain both power generation and display functions, a maximum display model providing full display functionality regardless of generation impact when content delivery is prioritized, an emergency mode that ensures notifications are displayed regardless of power considerations, and the like.

The power management system 128 may continuously optimize power generation factors (e.g., positioning of the solar arrays, control parameters of the displays 146) depending on the selected mode (e.g., as instructed by the controller 126) and based on current power generation, battery storage status, grid conditions (where there is a grid connection), and/or predicted conditions to make real-time adjustments. In embodiments, the controller 126 may monitor the various factors that impact power generation as described herein and transmit operation mode selections to the power management system. For example, during periods of high electricity value (e.g., for grid-connected systems) or low generation, the controller 126 may instruct the power management system to enter a mode that may automatically reduce display power consumption by decreasing brightness, limit active screen areas, and/or the like.

In multi-array networked systems, the power management system 128 may coordinate load balancing between arrays. For example, arrays with excess generation capacity may support more power-intensive display operations and/or compensate for extra power drawn by displays 146 at other arrays, while arrays with constrained capacity may operate in reduced display mode, rely solely on pole-mounted or peripheral displays 146, or receive power from other arrays with excess capacity.

The power management system 128 may also provide information to other system components that interact with advertising marketplace systems, such as data on available display capacity based on associated power availability. The power management system therefore may support dynamic pricing of advertising slots based on current and predicted power economics, enabling a solar installation to charge higher rates for content displayed during periods of high generation capacity and/or discounted rates when there is excess power to operate displays 146.

For installations displaying public service announcements or emergency information, the power management system may operate to ensure that information is displayed regardless of power considerations. The power management system may maintain sufficient reserve capacity, either through battery storage or grid connection, to guarantee operation during these and other situations in which displays of important information must be prioritized over power generation.

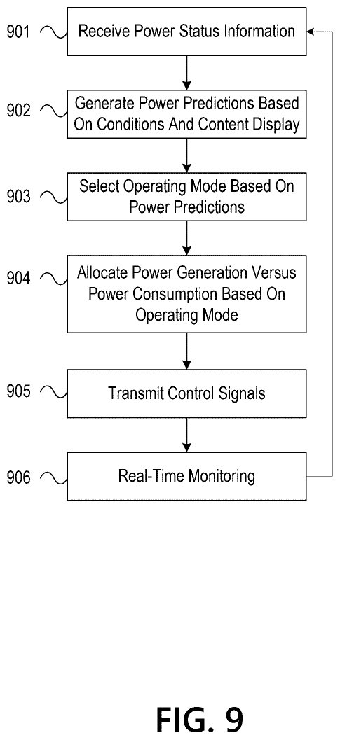

FIG. 9 illustrates an example power management flow that may be implemented by the main controller 126 together with the power management system 128. At step 901, the main controller 126 and/or the power management system 128 may collect various measurements from across the installation 100. For example, sensors may continuously monitor solar insolation levels at multiple points across the array to capture transient conditions such as passing cloud cover. The controller 126 may collect and generate power generation metrics at the individual system 102 level and/or aggregate installation 100 level, including voltage, current, and power output measurements. The controller 126 may further monitor display power consumption with metrics for each display component, for example capturing power consumption on a per-display basis, aggregated across type of display, aggregated across all displays 146 of an installation, etc. The controller 126 may also collect state-of-charge information from battery management systems, including charge/discharge rates, temperature profiles, cycle counts, etc. For grid-connected installations, the controller 126 may interface with grid monitoring equipment to track current electricity rates, demand signals, grid stability parameters, and the like. The controller 126 may synchronize the collected data using timestamps and store the collected data in the storage 132 for use in short-term operational decisions and/or long-term performance analysis.

At step 902, using the data stored in storage 132, the controller 126 may predict future conditions, which may be useful for proactive optimization of power management. For short-term forecasting (e.g., minutes to hours), the controller 126 can generate predictions using one or more of persistence models, linear extrapolation, sky-imaging techniques, or the like to predict imminent changes in solar insolation. For medium-term forecasting (e.g., hours to days), the controller 126 may analyze data from external weather data feeds, satellite imagery, weather model outputs, specialized solar irradiance prediction services, and/or the like. The controller 126 may also generate display power need predictions based on scheduled content, for example using historical power consumption data, power consumption metadata associated with each content item in the display queue, or the like. For grid-connected systems, the controller 126 may generate predicted electricity pricing based on historical patterns, day-ahead market signals, scheduled demand response events, and the like. In embodiments, the controller 126 may use ensemble techniques to combine multiple prediction methods. The controller 126 may continuously improve forecast accuracy by evaluating predictions against actual data and retraining predictive models using machine learning algorithms in order to adapt to local conditions and system-specific characteristics.

At step 903, the controller 126 may evaluate current state data from step 901 and forecast data from step 902 to select an optimal operating mode according to programmed priorities. For example, the selection algorithm may use weighted decision matrices that may consider factors such as current storage capacity (which may be weighted more heavily for off-grid systems), differentials between current/forecasted generation and consumption, electricity pricing signals (for grid-connected systems), scheduled display priorities, and the like. The algorithm may use configurable thresholds (which may have hysteresis parameters to prevent rapid mode oscillation that could degrade user experience or system performance). For example, transitioning from a “balanced” or “revenue-maximizing” mode to a “generation priority” mode may require a battery state-of-charge to fall below a threshold (e.g., 30%) and forecasted generation to remain below consumption needs for a period of time (e.g., 60 minutes), while recovery to the balanced mode might require state-of-charge to exceed a higher threshold (e.g., 50%) with positive energy balance forecasted for another period (e.g., the next 120 minutes). The controller 126 may also consider scheduled overrides for special events, emergency conditions, or operator-defined priority periods. A selected mode may be used to establish an operational framework for subsequent power allocation decisions, including priority hierarchies for different system functions and acceptable performance ranges for display components. Additionally or alternatively, the controller 126 may output relative priorities instead of discrete modes; for example, the controller 126 may determine a target amount of power to generate and then allow the system to operate in a revenue-maximizing mode as long as the target power is being generated.

At step 904, within the constraints of the selected operating mode and/or other priorities set at step 903, the power management system 128 may generate operation instructions for various controllable components in the system. For example, for display components, the power management system may, in some cases, select operating status (e.g., off or on) and/or determine maximum power consumption (which may be enforced by the power management system 128 and/or other systems such as the content management system 144, which may reduce brightness, turn off portions of the display, or use other strategies described herein to limit power consumption). The power management system may also control power distribution to auxiliary systems such as audio components (e.g., by selectively enabling or disabling optional systems), cooling systems for high brightness displays 146, mechanical systems for deployable or articulating components, and the like. Power allocation decisions may be based on priorities associated with a current operating mode, ensuring that important functions receive power before lower-priority functions. For example, in a generation priority mode, the power management system might restrict displays 146 to 40% maximum brightness and disable auxiliary audio systems to preserve power, while in a display priority mode, the power management system might allocate full power to primary display surfaces while managing secondary displays 146 based on available energy. The power management system may use load balancing for multi-array installations to distribute power consumption across multiple interconnected units based on their individual generation capacity and/or storage states. For tracking-enabled arrays, the power management system may determine optimal positioning that balances generation efficiency against display visibility requirements. In some cases, this may involve tracking within a limited range of motion that is set based on content viewing requirements as opposed to maximum power generation (e.g., thereby selecting better viewing angles instead of a position that provides the maximum power generation). In embodiments, the power management system may implement time-sharing to alternate between positions optimized for different priorities (e.g., generation versus display priorities).

At step 905, based on the decisions and/or instructions generated at step 904, the power management system 128 may generate and distribute control signals to managed components. The signals may include command signals sent to display controllers 148 (e.g., specifying maximum power usage), power routing commands to charge battery controllers, inverters, and/or battery management systems to implement desired energy flows, positioning commands to tracking system actuators with specific azimuth and elevation ranges or targets, and operational state commands to auxiliary components 114. The power management system may use sequencing logic to improve transitions between states (e.g., to prevent visual artifacts in displays 146 or destabilizing power surges). For example, when reducing power to a display, the power management system may instruct a gradual power reduction to avoid abrupt display changes.

At step 906, the power management system 128 may continuously monitor conditions in real time and repeat the previous steps, creating a loop that validates the effects of executed commands and adapts system behavior based on changing conditions. The power management system may monitor conditions on an ongoing basis to capture the actual impact of power allocation decisions, which may include tracking metrics such as realized power generation against expected values, actual display consumption against target settings, and user experience factors such as content visibility under current ambient conditions. When discrepancies are detected between expected and actual outcomes, the power management system may take corrective actions while also feeding the information into training data sets for retraining predictive models to improve future decision-making. The power management system uses machine learning techniques (e.g., generating a loss function and back propagating loss reductions through a neural network) to continuously refine relevant predictive models. The machine learning models may include supervised learning models trained on historical performance data that optimize forecasting accuracy, reinforcement learning algorithms that improve mode selection decisions based on observed outcomes, neural network models that enhance power allocation efficiency by identifying non-obvious patterns in system behavior, and the like. The power management system may store performance history to support automated optimization as well as manual analysis by system operators.

### Content Management

The content management systems 144 described herein may control what content is displayed via the dynamic displays 146 using a variety of techniques described in more detail herein. The content management systems may be responsive to instructions provided by the controllers 126, which may selectively prioritize revenue generation via dynamic display (e.g., using ads or other revenue-generation displays), revenue generation via power generation, other display priorities (e.g., emergency content display, display of other important information), or other power generation priorities (e.g., sufficient power generation to maintain battery storage, supply building loads, and/or the like). Content management may be used as a factor in balancing the above objectives.

Content management may also be responsive to a current status of the solar installation 100 and/or solar array display system 102. For example, the content management system 144 may select content for display based on amounts of power being generated by the installation 100 and/or solar array display system 102, based on power stored via power storage systems 138, based on a direction that the display(s) 146 are facing (e.g., such that certain content may be prioritized or deprioritized for display when a solar array is facing towards more or fewer likely viewers), and other such factors. Thus, in some cases, the content management systems 144 may be responsive to factors that are under control of the power management system 128. This relationship may be particularly apparent in operating modes in which power generation is being prioritized, for example such that the power management systems 128 rotate the array to maximize power generation system, thereby impacting whether (and/or the extent to which) one or more displays 146 are visible or not.

The content management systems 144 may, either alone or under control of the controllers 126, use several techniques to select and display content via one or more displays 146. In example embodiments, the content management systems may schedule visual content for better user impact and/or system efficiency, so that, for example, daytime content may be formatted to minimize array blockage during sunny hours, transitioning to different (e.g., more elaborate) content at night where power generation loss is less concerning. In some cases, the controller(s) 126 may use models that track historical light levels, sunset/sunrise times, etc. to predict light levels at a given time of day for planning purposes. Additionally, or alternatively, the controller(s) 126 may be in communication with sensors that detect current light levels, which the controllers 126 may communicate to the content management system. Based on the current and/or predicted light levels at a given time of day, the content management system may select certain visual content for display based on the impact of the content on power generation. The content management system may be configurable to display visual content in any combination of image (e.g., JPEG or PNG, etc.) and digital and/or analog video (e.g., DTV, NTSC, etc.) inputs. The content management system may maintain a schedule of image or video content that may be generated and/or modified based on any of the above factors. For example, the content management system may generate an initial schedule (e.g., for a day) that assigns different content to different time slots based on historical and/or predicted light levels, weather, battery levels, predicted array directions, etc. in order to optimize power generation and visual content impact. In this example, content that may tend to block more visible light (e.g., because it is more visually detailed or otherwise activates more pixels of the transparent display or otherwise has higher opacity) may be scheduled during periods of no or low power generation (e.g., at night, during sunset or sunrise, etc.), whereas content that tends to block less visible light (e.g., because it activate fewer pixels and/or otherwise has less opacity) may be shown during more intense sunlight. However, it should be understood that these are only example decision that may impact the generation of a schedule. For example, an advertiser may be willing to pay higher prices for a particular time slot during peak power generation. In some cases, the schedule may also include time when the display is totally disabled (e.g., to maximize power generation).

The content management system 144 may deviate from a visual content schedule for various reasons. For example, the visual schedule may be interrupted due to the need to display emergency content (e.g., a PSA such as an Amber or Silver Alert or weather alert), a lower or higher than expected power generation (e.g., because of unexpected weather and/or light changes), a lower or higher than expected battery level (e.g., because of unforeseen changes in demand), a lower or higher than expected price paid by an energy utility for excess generated power, and/or the like.

Additionally or alternatively, the content management system 144 may (sometimes or always) avoid the use of predefined schedules, and accordingly may select visual content to display dynamically based on any or all of the above-discussed factors as well as additional factors such as the amount of revenue paid by an advertiser for display of an advertisement.

In some cases, the content management system 144 may be connected to a dynamic advertising marketplace that allows an advertiser to bid on time slots for displaying their visual content, which may be for the present moment or in the future. In some cases, the content management system may price the ad availability slots based on factors such as the opacity of the content, expected viewership (which may be a factor of the direction that an array is rotated, which may significantly impact visibility), the amount of current sunlight and/or predicted future sunlight, current battery storage, current demand for power, current power resale prices, location of the solar array, and/or the like.

In addition to “programmed” content as described above, array images may be derived from other sources such as video cameras. In one such application, for example, content from a camera facing rearward from the solar array and projected on an array display 146 would give the visual impression that the array is mirroring and blending into the background scene, enabling an on-demand “stealth mode” reducing the array's visual presence. In addition to projecting literal scenes that enable the stealth-mode, the array could also project visually disruptive patterns, such as those based on established camouflage patterns or AI-renderings using the rearward-facing camera imaging content. In these embodiments, one or more of the main controller 126 and/or the display controller 148 may process video inputs from the camera(s) using image and/or video processing techniques (e.g., blurring), machine learning techniques (e.g., AI rendering and/or modification), and/or the like to generate video for display on the solar array or other visual display surfaces.

In embodiments, the content management system 144 may provide a user interface that allows administrators to create content schedules or otherwise configure content management, parameters, priorities, content storage, and the like. Additionally or alternatively, the content management system may provide application programming interfaces (APIs) that may allow third-party systems to submit content, retrieve performance data, control display operations, bid on ad space provided via the display, and/or the like.

In embodiments, the content management system 144 may adjust display settings to minimize power usage in some cases. For example, during evening hours or periods of minimal solar generation, the content management system may transition to a power-conserving display mode that may optimize the use of stored energy for content display. In this mode, the content management system may reduce refresh rates, limit display pixel activation, cycle content between multiple content displays 146 rather than showing them simultaneously, and/or the like.

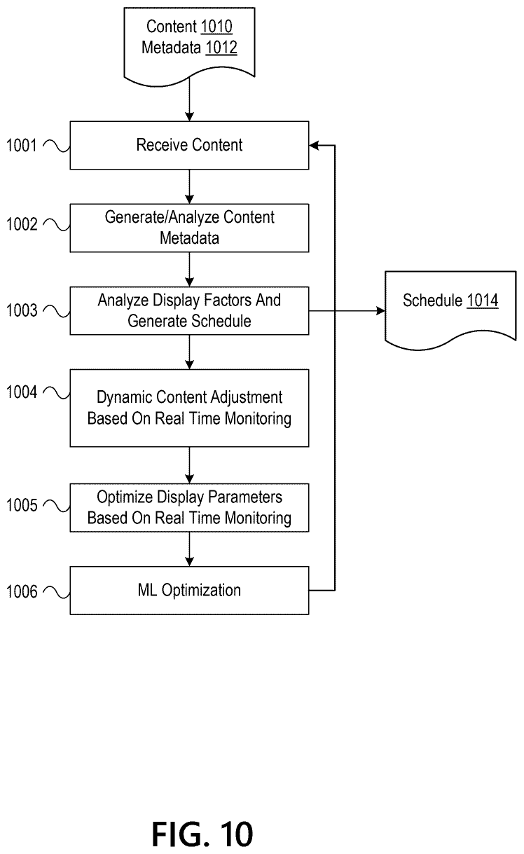

FIG. 10 illustrates a content management workflow that may be implemented by the content management system 144 to schedule and/or dynamically select visual content for display. During a content acquisition step 1001, the content management system may receive content from various sources (e.g., advertisers, public service announcements, informational content generators, system status data, etc.). In embodiments, each received content item 1010 may be associated with metadata 1012 that defines one or more characteristics such as display duration, priority level, power consumption impact (e.g., based on content opacity and pixel activation percentage), advertising info (e.g., price to show a content item, ad targeting information, etc.) scheduling preferences, and the like.

Additionally or alternatively, at step 1002, the content management system 144 may analyze the received content to generate additional metadata 1012 that is not received with the content. For example, the content management system may use image processing algorithms to analyze content to determine power consumption impact. The image algorithms may include a pixel intensity analysis that calculates the percentage of activated pixels and their brightness levels (e.g., as averages over a period of time in which the content is displayed), histogram analysis to determine overall content brightness distribution, edge detection to identify content complexity, image segmentation to isolate darker versus lighter regions, and/or the like.

Content acquisition 1001 may take place periodically or continuously. For example, the content management system 144 may continuously receive new and/or updated content and execute the remainder of the method (e.g., updating a schedule, etc.) based on the new and/or updated content.

At step 1003, the content management system 144 may perform a real-time analysis of multiple display-related factors to generate a schedule 1014. In some cases, these factors may include prioritization instructions received from the controller 126. For example, the controller 126 may instruct the content management system 144 to prioritize revenue generation, to prioritize specific types of content, to prioritize power generation, to shut down display of content, and/or the like. Additionally or alternatively, the factors may include conditions such as current and forecasted solar conditions (e.g., time of day, cloud cover, seasonal sun position), current power generation levels, rotational status of the displays 146 of each system 102 (which may impact content visibility), energy storage status (e.g., battery charge levels), power grid conditions (including current electricity pricing for selling excess power), current viewing conditions (e.g., ambient light levels, expected numbers of viewers and/or numbers of viewers indicated by sensors), and/or the like. The content management system may then generate display decisions for a content schedule based on the content metadata and the operational factors. In some cases, the content management system 144 may use a priority ranking of content that first displays highest priority content (e.g., emergency content such as Amber Alerts or severe weather warnings if present), then schedules other high-priority content (e.g., premium-paid advertisements) in the best conditions (e.g., on displays 146 with the best viewing angles, most high traffic and/or visible time slots and/or displays), then schedules standard priority content, and finally schedules lower priority content in remaining conditions.

In some cases, the content management system 144 may generate, for an item of content, an overall revenue value that quantifies a trade-off between power generation revenue loss and display revenue or value. This value may indicate, for example, an overall revenue for each potential content item based on current power generation conditions, solar array display system 102 conditions (e.g., viewing angle, estimated viewership), electricity market prices, and the content's revenue value. The content management system may use the overall revenue value as a measure of priority for scheduling content, such that, for example, content with more favorable values may be prioritized for display. Thus, the content management system 144 may select content at least partially based on power generation factors and/or at least partially based on revenue generated by the content itself. In these embodiments, when content is associated with a low or negative overall revenue value, it may be rescheduled for a different time.

In embodiments, the content management system may generate a schedule 1014 that assigns certain content (e.g., high priority and/or high revenue content) to multiple arrays, which may require synchronizing content across array-based displays 146, pole-mounted displays 146, and/or peripheral displays 146, as described in more detail below.

As part of the generating the schedule 1014, the content management system 144 may consider display parameters for the scheduled content. For example, the content management system may schedule content with adjusted transparency levels (e.g., for dynamic displays 146 that may block insolation) to balance visibility with power generation. Additionally or alternatively, the content management system may select appropriate display locations for content to maximize revenue (e.g., array-mounted, pole-mounted, and/or peripheral displays, if multiple types of displays are available) based on content requirements, current array orientation, timing parameters for content, and/or the like. Additionally or alternatively, the content management system may generate instructions to better position one or more displays 146 for particular scheduled content (e.g., displays 146 that can articulate independently of the solar array display system 102 may be articulated to maximize viewership and/or the array display system 102 as a whole may be rotated to prioritize display angle over maximum power generation).

At step 1004, the content management system 144 may adjust a schedule 1014 based on changes to real-time conditions or other real-time factors. Alternately, in some cases the content management system may skip schedule generation (e.g., step 1003 may be optional) and may simply dynamically select content based on continuously monitoring real-time conditions during content display without regard to any schedule. In any of these embodiments, the real-time conditions may include sensor data, status of one or more sub-systems (e.g., rotation status of one- or two-axis tracking systems), or other information provided by the controller 126. In some embodiments, the content management system may track actual power generation impact compared to predicted values (e.g., from content metadata). The content management system may also perform other monitoring, such as logging actual traffic (e.g., from sensors that track cars and/or viewers in the area), analyzing current brightness levels, and/or the like.

When the content management system 144 generates schedule adjustments (e.g., selecting different content for current display, rescheduling content for another time, etc.), the schedule adjustments may be based on monitored values departing from predicted values or other thresholds for taking action being triggered, such as if one or more displays 146 are rotated into or out of certain viewing angles.

At step 1005, the content management system 144 may adjust displays 146 in real-time during content display to optimize system performance, such as by modifying display brightness or transparency in response to unexpected cloud cover or changing ambient light conditions (e.g., as indicated by data received from the controller 126), repositioning displays 146 and/or tracking systems to adjust a balance between content visibility and power generation, substituting content when higher priority content (e.g., emergency messages) need to be displayed or when actual conditions significantly deviate from predicted conditions, and/or the like. Additional strategies may include selective pixel activation, such as by limiting active pixels to those essential for content visibility; color optimization, such as by selecting color palettes that minimize power consumption on specific display technologies; content positioning, such as by placing content on portions of the display that minimize impact on high-efficiency solar cells and/or minimize power consumption, and the like.

At step 1006, the content management system 144 may use machine learning techniques to continuously improve schedule decision-making and/or dynamic adjustment of displayed content based on historical performance data. For example, the component may gather training data that illustrates relationships between variables such as display configurations (e.g., rotation, display settings), content metadata, and other input data versus outcome data such as power generation outcomes and/or measurements of content effectiveness. This data may be used to continuously refine decision models (e.g., neural networks or other ML models) that may be used by the system to predict the impact of content display on power generation or other target data. For example, the content management system may train and retrain a model by feeding training data into the model to generate predictions, comparing the generated predictions to the actual target data from the training data set, computing a loss based on the difference between the generated prediction and the actual target data, and updating the weights of the model using backpropagation algorithms (e.g., gradient descent). Such a model may be periodically retrained with updated training data to maintain prediction accuracy over time and adapt to variations.

In embodiments, the content management system 144 may also be configured to generate and display information content for various purposes. For example, the system may display dynamic visualizations that demonstrate an “array to EV” power path, showing in real-time how solar energy is captured, converted to electricity, and transferred to electric vehicles at charging stations. These and other visualizations may include animated graphics (e.g., showing energy flow from the solar panels to power storage systems 138 and then to EV charging stations, with changing visual elements that correspond to actual power generation rates).

Additionally, the content management system 144 may display metrics and statistics related to the installation 100, such as an environmental impact and/or performance of the solar installation. This informational content may include data such as “metric tons of CO2 avoided” through the use of solar power instead of fossil fuels, “kilowatt hours produced” over various time periods (e.g., today, this week, this month, since installation), or “number of electric vehicles charged” during a given day, week, month, etc. The controller 126 may store data for tracking these metrics in real-time and the content management system may update the displayed information accordingly. The content management system may present various metrics using graphics, charts, counters, and the like.

The content management system 144 may also be configured to display public service announcements and emergency information. For example, the system may be configured to display textual and/or visual content such as Amber Alerts, Silver Alert, severe weather notices such as tornado warnings, flash flood alerts, or evacuation orders, and the like. During emergencies, the content management system may override normal content scheduling to prioritize public safety messages or other important content.

In some implementations, the content management system 144 may allow local government agencies or other sources of important information to directly push emergency notifications to the display system through secure API connections, thereby enabling rapid dissemination of information. The content management system 144 may also be configured to monitor and display specific types of emergency alerts, such as severe weather warnings, without manual intervention.

### Coordination Across Multiple Displays

In embodiments, the content management system 144 (which may be a networked content management system in communication with a plurality of solar arrays) may control the displays 146 associated with a plurality of solar arrays in concert, where each solar array may display visual content (e.g., on various displays and/or on a screen reflecting content displayed by a projector), to create a large-scale unified display of visual content. For example, the content management system 144 may control the plurality of solar arrays to orient the plurality of solar arrays (and/or independently-articulable displays 146) so they each face the same direction and/or each face towards the same point (e.g., to create a “curved screen” effect). In these embodiments, the content management system 144 may synchronize the display of different portions of a single piece of visual content on the different displays 146 in order to generate a large-scale visual content across multiple displays and/or solar arrays. Additionally or alternatively, the content management system 144 may direct a first subset of the displays and/or solar arrays to collectively display a first item of visual content (e.g., in a first direction) while directing a second subset of the displays and/or solar arrays to collectively display a second item of visual content (e.g., in a second direction), and so on, thereby allowing for the display of multiple items of visual content simultaneously. The content management system may therefore dynamically adjust the orientation (e.g., rotation in any axis) and display of visual content across multiple displays and/or across multiple solar arrays over time as desired. It should be noted that the content management system may use these or other collective display features to display visual content that spans across multiple solar arrays with dynamic displays 146 that do not use projectors, with display screens that use projectors, with displays 146 that are mounted to poles or elsewhere, and/or any combination thereof.

For multi-array content, the content management system 144 may synchronize timing of various portions of the content across multiple arrays, which may include compensating for network latency to ensure that coordinated presentations remain synchronized regardless of physical distribution. For example, the content management system may use buffers to compensate for network latency and schedule each portion of content for a specific synchronized time. The content management system may use content chunking algorithms that automatically divide larger content pieces across multiple displays 146. The content management system may maintain information regarding different display sizes, resolutions, and relative positioning, which it may use to perform the content chunking. In some embodiments, the content management system may use geometric mapping algorithms that account for the relative positions and orientations of arrays, display sizes and resolutions, viewing distances and angles, and potential gaps between displays 146. The content management system can use the geometric mapping algorithms to transform content coordinates from a unified virtual canvas to the appropriate positions on individual displays 146.

In embodiments, the content management system 144 may also coordinate the display of content between array-mounted displays 146 and other displays 146 (e.g., pole-mounted displays) to create unified or complementary visual experiences. This coordination may take various forms depending on installation objectives, viewing conditions, and/or power generation requirements. For example, the content management system may implement cross-display content strategies including complementary content display, where pole-mounted displays show detailed information while on-array displays may show simpler, less power-impacting visuals; sequential narrative progression, where content begins on pole-mounted displays and continues across array-mounted displays or vice versa, thereby creating a combined display; fallback display systems, where pole-mounted displays can maintain visibility of content during periods when array displays are repositioned to maximize power generation; and ambient/focal display coordination, where array-mounted displays may display ambient visual content (e.g., content for long-range viewing) while pole-mounted displays may deliver high-resolution focal content designed to capture viewer attention.

The content management system 144 may implement coordination techniques to manage different display types effectively. For array-mounted displays with transparency considerations, the content management system may dynamically adjust content opacity based on power generation needs as described elsewhere herein, while simultaneously sending full-opacity versions of similar content to pole-mounted displays, in order to better balance visual impact with power generation. The content management system may also store and display separate versions of content optimized for the technical capabilities of different display types. For example, high-detail, high-contrast content may be displayed on pole-mounted displays whereas simplified, high-transparency content may be displayed on array-mounted displays. The content management may also dynamically transcode content to generate content in optimal formats for each display type.

The content management system 144 may determine optimal content placement across different display types based on factors including display visibility from viewer position (e.g., pole-mounted displays may have better visibility at certain times of day or from certain viewing angles), power impact considerations (e.g., prioritizing pole-mounted displays for power-intensive content during peak solar hours), content characteristics (e.g., text-heavy content may be directed to pole-mounted displays, while more visual/graphical content may be suitable for array displays), viewer engagement patterns (based on analytics data showing how different display types perform for different content categories), and/or current array orientation (which may make certain array-mounted displays more or less visible than pole-mounted displays from particular viewing positions).

The multi-array content management system 144 may also maintain information indicating the absolute and/or relative positions of each solar array and/or associated display to allow content to flow from array to array based on physical positioning. For example, the content management system may, using scheduled timing offsets for related portions of content, schedule sequential narratives that unfold across arrays positioned along a highway. In this example, the content management system may use relative timings that are determined based on the distance between arrays and on typical travel speeds in the area. For example, the content management system may implement frame-accurate synchronization using timed playback commands, frame buffering with synchronized release, and distributed rendering with local timing adjustments. The content management system may send timing references to each display to ensure frame-by-frame alignment across all displays 146.

The multi-array content management system 144 may comprise one or more networked content management systems (which may be part of networked control systems 134) in communication with one or more control systems 140 of individual solar array assemblies connected via communication links. In some cases, a single centralized content management system may manage all arrays. Additionally or alternatively, multiple content management systems may use a distributed architecture where control functions are shared among multiple content management systems associated with individual arrays. Hybrid approaches with both centralized coordination and local array-specific controllers 126 are also possible.

The content management system 144 may manage storage of media assets. For large-scale installations, the content management system may implement content caching at different network levels (e.g., at centralized storage and/or at individual arrays) to reduce bandwidth requirements and improve responsiveness. Local caches at each array may, for example, store frequently used content, reducing the need for repeated transmission across the network.

In embodiments, the content management system 144 may control the positioning (e.g., rotation) of one or more articulable displays 146 in order to arrange a larger virtual display made up of a plurality of individual displays 146. This positioning control may include one or more of rotating a solar module (e.g., using one- or two-axis tracking system) to adjust the display angle of a display mounted to the solar module, adjusting the positioning and/or rotation of one or pole-mounted displays or edge-mounted displays (as described elsewhere herein), deployment of projection screens or other display elements, and other such positioning commands that may adjust the position of displays 146.

In embodiments, the content management system 144 may calculate absolute positioning using shared coordinate systems and/or relative positioning for creating specific geometric arrangements of displays 146. The content management system may use motion profiling for coordinated movements to increase the smoothness of transitions between display configurations. When arrays are positioned in close proximity, the content management system may account for physical interference between units to prevent collisions.

In embodiments, content management systems 144 may track moving viewers, respond to environmental conditions, or otherwise dynamically change. The content management system 144 may, in these cases, receive and combine data from multiple arrays to create unified situational awareness. For example, the content management system may create a “digital twin” of an entire solar facility, including current positioning for each solar array, sensor readings for each array, and/or the like. In addition, the digital twin may aggregate and analyze shared data from light sensors, cameras, weather instruments, and viewer tracking systems across the entire installation.

The multi-array architecture described herein may scale from small installations with just a few arrays to large deployments with hundreds or thousands of coordinated displays 146. As such, the content management system may implement scalability features including hierarchical control structures (e.g., with regional sub-controllers 126), distributed content delivery networks, load balancing across multiple controllers 126, and automated configuration and provisioning for new arrays. For geographically distributed installations spanning multiple locations, the content management system may implement wide-area network optimization techniques, regional content caching, zone-based control structures, and latency compensation algorithms to maintain synchronization despite varying network delays across distant locations.

The content management system 144 may support dynamic reconfiguration by allowing arrays to be added to or removed from the network without disrupting ongoing operations.

For installations serving advertising content, the content management system 144 may interface with real-time ad bidding services to allow programmatic advertising systems to purchase display time across the array network. In embodiments, the content management system may price and/or place ads based on array visibility, viewer demographics, number of screens used for multi-array display, size of the “virtual display” made up of multiple individual displays 146, and the like. In embodiments, the content management system 144 and the power management system 128 may coordinate to balance commercial display with energy production requirements, such as by using subsets of solar arrays for power generation, other subsets for advertisement display, and the like.

### Integrated Projector for Displaying Projected Visual Content

In some embodiments, the solar array may be used to display visual content that is output by a projector. These embodiments may be combined with the static and/or dynamic visual embodiments described above. For example, the dynamic and/or static images described above may be displayed using a projector that projects the visual content onto the surface of the solar array itself and/or onto an integrated projector screen. For example, projectors may display the same visual content as directed by the same controller 126 and/or other control system 140 described above. In other words, the projectors may be a suitable drop-in replacement for the dynamic displays 146 described above. In some cases, a projector screen may be constructed using some or all of the techniques described above for static content (e.g., to allow for deploying a projector screen while still allowing at least partial use of the underlying solar panel). The projector and/or (optional) projector screen may be integrated with each other using various methods as described herein.

In some cases, a projector may be attached to the solar array, such as via a projector bracket or other holder, as shown in FIG. 3A. In these cases, the projector may be aimed so as to project visual content on the entirety or a portion of the solar array. Additionally or alternatively, a freestanding projector (e.g., as shown in FIG. 3B) may project visual content on the solar array. The projectors may use various types of display technologies (e.g., DLP, LCD, LCOS, LED, laser, etc.) and throws (e.g., standard distance, short throw, ultra short throw, long throw, zoomable, etc.) depending on application and intended use (e.g., depending on the size of the solar array, whether the projector is attached or freestanding, intended usage in various light levels, budget, etc.). For example, shorter throw projectors may be more useful when the projector is attached to the solar array (e.g., to reduce bracket size for robustness and/or wind resistance, to allow integration into a weatherproof enclosure for the solar array, etc.), whereas longer throw projectors may be more suitable for a freestanding configuration.

An attachable integrated projector (e.g., as shown at FIG. 3A) may have the benefit of allowing use of the projector at various rotations, azimuths, elevations, etc. For example, when the projector is attached to the solar array, the solar array may rotate along any axis of rotation or otherwise change position and still maintain a fixed angle between the projector and solar array, thus allowing for the repositioning of the solar array prior to and/or during the display of visual content. In some cases, the solar array may be repositioned prior to display of visual content in order to provide the visual content in a selected direction (e.g., towards a busy roadway) at a selected elevation (e.g., vertical) in order to optimize the visibility of the visual content. Additionally or alternatively, the solar array may be rotated during the display of visual content to provide dynamic visual effects. After or during the display of visual content, the solar array may be repositioned in order to increase power generation. In these examples, a controller 126 or other control system 140 (e.g., as described above) may determine whether to position a solar array to optimize power generation, visual content visibility, and/or a hybrid approach that allows for some power generation while also providing for visual content visibility based on any or all of the above-described factors (e.g., ad placement strategies, amount bid for ads, amount of energy stored, cost of electricity on the grid, important public service announcements, etc.).

In some cases, a solar array may be improved for use as a projector by attaching a movable (e.g., stowable) reflective screen. In these cases, the reflective screen may be turned “off” (e.g., stowed) when the solar array is used to capture solar energy and turned “on” (e.g., deployed) when the solar array is used as a projector screen. An example implementation of a stowable reflective screen is described in more detail below with respect to FIGS. 4A-4G).

Other types of switchable reflective screens are contemplated. For example, a projector screen may be constructed of electrochromic glass, a polymer-dispersed liquid-crystal device, a suspended-particle device, or the like. These devices may be constructed to switch their light transmission properties in response to the application of voltage. For example, electrochromic glass may be switched “off” to provide transparency during power generation and switched “on” to act as a projector screen during projection of visual content.

A reflective projector screen may incorporate other mechanical elements. For example, a screen comprising louvers or micro-blinds may operate to place the louvers or micro-blinds in an open position that allows light to pass during power generation and a closed position that reflects light during the projection of visual content.

A deployment and retraction system (e.g., as illustrated below at FIGS. 4A-4G) may incorporate limit switches or position sensors at the fully retracted and/or fully deployed positions to prevent over-extension or over-retraction. Additionally, torque-sensing capabilities may be incorporated into a roller motor control system to detect obstructions during operation, automatically halting movement to prevent damage.

For installations in extreme environments, the deployable screen system may incorporate features such as heaters to prevent ice formation in cold climates, forced-air ventilation to remove moisture in humid environments, or automatic retraction capabilities triggered by wind speed sensors, rain sensors, or the like. In embodiments, the controller 126 may transmit indications that the control system for the deployable screen should automatically retract the screen (e.g., in advance of approaching storms) based on predictive weather models, bad weather reports, or the like.

The deployment and retraction sequences may be managed by the controller 126. The controller 126 may determine optimal deployment times based on the factors described above, including operation modes, ambient light levels, power generation needs, scheduled content display times, environmental conditions, and the like.

In embodiments, the power management system 128 may determine when sufficient power is available to operate projectors based on current solar generation, battery storage levels, and grid conditions as described above. For example, during periods of high energy demand or low generation, or during a power generation priority mode, the power management system may automatically disable projections and/or stow projector screens to conserve power and/or improve power generation. Conversely, during surplus power generation, the system may deploy projection screens and/or switch on other projection systems 116 to display visual content to maximize visibility.

In embodiments, the content management system 144 may select content for projection based on various priorities and scheduling determinations as described above. The system may also use weather forecasts to modify projection system scheduling. For instance, if adverse weather is predicted, the system may preemptively display high-priority content before conditions deteriorate due to expected screen retraction prior to high winds or precipitation.

In networked installations with multiple solar array display systems 102A-N, the projection systems 116 may receive synchronized instructions from networked control systems 134 to coordinate visual content across multiple arrays, creating larger, synchronized visual displays spanning multiple projection surfaces, as described above.

### Pole-Mounted and Other Peripheral Displays

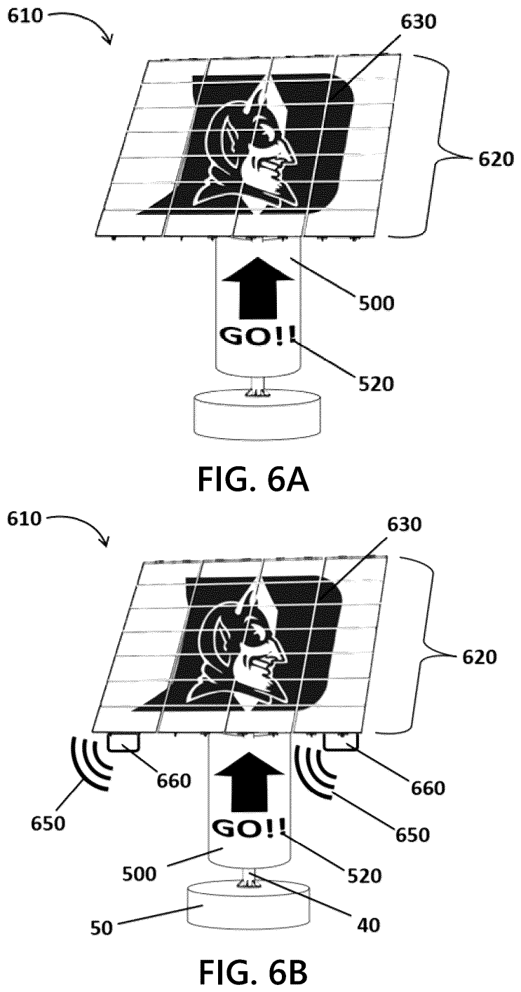

In embodiments, displays 146 may be placed on mounting infrastructure such as poles in order to avoid obstructing the insolation of solar arrays, to provide better viewing angles for viewers, and/or the like. These pole-mounted displays (and other displays 146 arranged on mounting infrastructure) may display any of the static or dynamic visual content described herein, either independently or in conjunction with the display of content on the other static or dynamic displays described elsewhere herein. In embodiments, the pole-mounted displays may be structured in various configurations, including wrap-around displays as described below with respect to FIG. 5A, which may be positionable as described below with respect to FIG. 5B, flat or curved displays 146 as described below with respect to FIG. 5C, which may also be positionable as described below with respect to FIG. 5D, and the like. These displays 146 may be combined with other displays 146 as described below with respect to FIG. 6A, and may optionally synchronize with audio content in embodiments that use audio speakers, as described below with respect to FIG. 6B.

Other peripheral display panels, such as the peripheral display panel 830 shown in FIGS. 8A-8C, may also display visual content without interfering with the solar array's power generation capabilities. The peripheral displays 146 may be integrated with the control systems 140, including the main controller 126, power management system 128, and content management system 144, enabling control of display content and physical orientation.

The pole-mounted and other peripheral displays 146 may be integrated with the control systems 140, including the main controller 126, power management system 128, and content management system 144 as described above. In particular, the control system 140 may control both display content as well as physical orientation for moveable peripheral displays.

In embodiments, the content management system 144 may manage the articulation mechanisms of pole-mounted or other peripheral displays to optimize viewing angles based on various inputs. For example, sensors may detect the presence and position of viewers, allowing the controller 126 to automatically adjust the display orientation to face approaching pedestrians or vehicles. During periods with no detected viewers, the content management system 144 may place articulating displays in a default position optimized for energy efficiency or visibility from the most common approach direction.

The pole-mounted and other peripheral displays 146 may include motorized articulation systems with various degrees of freedom. For wrap-around displays as shown in FIG. 5B, the content management system 144 may selectively activate different display segments based on viewer position, for example by illuminating only the portion facing viewers to conserve power. For flat or curved displays with articulation capabilities as shown in FIG. 5D or FIG. 8, the controller 126 may continuously adjust (e.g., pan and tilt angles) to track moving viewers or to transition between multiple viewing areas throughout the day according to programmed schedules.

The power management system 128 may prioritize power allocation among multiple pole-mounted or other peripheral displays based on current solar generation, battery storage levels, content priorities, and other power management factors. For example, during limited power availability, the power management system 128 may implement power-saving strategies such as reducing brightness levels, activating fewer displays, temporarily disabling articulation mechanisms to conserve energy, or the like. The power management system 128 may also coordinate with the main controller 126 to schedule high-power display operations during periods of excess solar generation, maximizing visual impact while efficiently utilizing available power.

The content management system 144 may coordinate synchronized content delivery across multiple pole-mounted and other peripheral displays, as well as other display types within the installation. For example, the content management system 144 may schedule related content on various screens such that content may move or flow between pole-mounted displays, peripheral displays, and solar array displays, or provide content on one screen that is related to content on another nearby screen. For installations near roadways, the content management system may use traffic sensors to trigger sequential content presentation that follows viewers as they move past multiple displays, as one example.

In embodiments with articulating displays 146, the content management system 144 may adapt content formatting based on the current physical orientation of the displays. For instance, if a flat display articulates from landscape to portrait orientation, the content management system 144 may reformat content (e.g., to adjust aspect ratios to the changed orientation and/or to maintain readability of text or other orientation issues). The content management system may also select specific content types suited to the current physical configuration of the display, for example by choosing between wrap-around panoramic content or focused messaging depending on which display type is currently active.

The main controller 126 and/or other control system 140 may coordinate articulation of the peripheral displays with the positioning of a solar array using a tracking system. For example, when the power management system adjusts the solar array using tracking systems to optimize power generation based on the sun's movement, the controller 126 may simultaneously adjust the peripheral rotation and/or angles of displays 146 to maintain optimal viewing angles for observers. In other words, the control system 140 may compensate for movement of the system 102 by coordinating compensatory movement of articulable displays to allow visual content to remain viewable even when an array's orientation changes throughout the day. As a specific example, when an array is rotating horizontally in a certain direction at a certain speed (e.g., due to the power management system adjusting the array to adjust power generation), control systems 140 may horizontally rotate a pole-mounted display in the opposite direction at the same speed to maintain a consistent viewing angle. Similarly, if an array is rotating vertically in a certain direction at a certain speed (e.g., due to the power management system adjusting the array to adjust power generation), control systems 140 may vertically rotate a peripheral display 830 in an opposite direction at the same speed to maintain a consistent viewing angle. In embodiments, maximum rotation angles of peripheral displays may be used to limit rotation of solar arrays when prioritizing content display over power generation.

The power management system 128 may prioritize power allocation for peripheral displays based on current conditions and other power management factors. During periods of limited solar generation or high-power demand, the power management system 128 may implement energy-saving measures such as reducing brightness levels on peripheral displays and/or temporarily disabling their articulation mechanisms. Conversely, during excess power generation, the system may increase display brightness or activate additional visual features to enhance content visibility and impact.

In embodiments, the content management system may place content on peripheral displays based on content that already exists on static overlays on an array surface. For example, the content management system may preferentially prioritize related content to be displayed on peripheral displays nearby static content. Alternatively, the content management system may preferentially avoid placing content on peripheral displays when nearby static content would create redundancies.

Integration with External Systems

The solar array display systems and installations described herein may be integrated with various external systems 136 and associated infrastructure to enhance functionality, provide additional services, and create broader value beyond standalone operation. These integrations may use various control systems 140, including the main controller 126, power management system 128, and content management system 144, to enable bidirectional communication with external platforms and systems 136.

In embodiments, the installations 100 may connect to commercial and residential building management systems (BMS). For example, such an integration may enable the displays 146 to function as information dashboards showing real-time building metrics such as current energy consumption, percentage of energy derived from solar versus grid sources, building carbon footprint, and the like. In embodiments, such integrations may create a visual feedback loop that can influence occupant behavior and demonstrate a building's commitment to sustainability.

In embodiments, the bidirectional integration may allow the BMS to provide inputs to the solar array's control systems 140 to optimize combined energy performance. For example, during peak building energy demand periods, the BMS may signal the power management system 128 to minimize display opacity or temporarily disable certain display features to maximize solar power generation. Conversely, during periods when the BMS indicates low building energy demand, the control systems 140 may display use more power for display content even if it reduces net solar generation and/or efficiency. Additionally, the content management system 144 may receive building occupancy data from the BMS to automatically adjust display content based on building usage patterns.

The control systems 140 may also interface with municipal management platforms through wired or wireless connections to provide public information services. For example, municipal traffic management systems may transmit real-time traffic information to the content management system 144, which may then format and display the traffic information on solar array display systems 102 positioned near roadways. The information may include congestion updates, accidents, alternate routes, road construction notices, and the like, which may be displayed in formats optimized for quick comprehension while driving.

Similarly, public transportation systems may send schedule information, service disruptions, or arrival times to the content management system 144 for display on arrays positioned near transit stops. Such an integration may enhance the utility of public transit systems by providing real-time information visible from a distance. Municipal event management systems may also transmit information about community events or public gatherings, thereby using the solar arrays as dynamic community bulletin boards.

The control systems 140 may be programmed to receive and prioritize emergency communications from authorized systems. Such integrations may use dedicated emergency communication protocols with appropriate security measures to prevent unauthorized triggering of emergency messages. When severe weather alert systems such as the National Weather Service's Emergency Alert System (EAS) send automated warnings, a main controller 126 can override regular display content to show important alerts. The power management system 128 may simultaneously adjust power allocation to ensure the displays 146 remain operational during emergencies, potentially drawing from battery storage 138 if grid power is compromised.

For public safety notifications such as Amber Alerts or evacuation notices, the networked control systems 134 can coordinate display across multiple solar array display systems 102A-N, creating a geographically targeted information network. The content management system 144 may adapt emergency messages based on specific display characteristics and/or viewing conditions to maximize visibility and comprehension.

In embodiments, the power management system 128 may establish bidirectional communication with utility grid management systems to participate in demand response programs, grid stabilization efforts, and/or energy market opportunities. Such integrations may use the solar installation's ability to dynamically adjust power generation versus display functionality based on external signals. For example, during utility demand response events, the power management system 128 may receive signals requesting increased power generation and respond by instructing the content management system 144 to temporarily reduce display size, brightness, or complexity. In some cases, the utility systems may provide incentive programs that compensate participants for reducing load or increasing generation during periods in which power is needed.

The main controller 126 may also process real-time energy pricing information from energy market platforms, then optimize system operation based on current energy values. For example, during periods of high energy prices, the controller 126 may instruct the power management system 128 to prioritize power generation over display functionality to capture premium pricing for excess generation capacity.

For installations with grid-connected inverters, the power management system 128 may respond to grid stabilization requests for reactive power support or other grid services while simultaneously managing display functionality, dynamically balancing these and other competing functions based on factors that may include grid needs, economic signals, content delivery commitments, and the like.

The content management system 144 may integrate with digital advertising platforms to enable the display of assets to generate revenue through automated advertising placement while maintaining power generation capabilities. For example, the content management system 144 may participate in real-time bidding for display space, allowing advertisers to place content on solar array displays 146 based on location, time of day, expected viewership (which may be based on viewing angle), or other targeting parameters. The system may also incorporate feedback from environmental sensors and cameras (when present and in compliance with privacy regulations) to provide audience measurement metrics such as estimated viewer count and viewing duration. The main controller 126 may coordinate between external advertising systems 136 and the power management system 128 to schedule high-value advertising content during peak visibility hours, while displaying less valuable content during peak solar generation hours when display brightness or opacity may be reduced to maximize power output. Thus, the system may optimize advertising revenue and energy production value based on real-time conditions.

The solar array display systems may also be integrated with electric vehicle charging infrastructure, thereby creating multi-functional installations that combine power generation, visual displays, and charging capabilities. The power management system 128 may dynamically allocate generated solar power between display operations, grid export, and/or EV charging based on real-time conditions and priorities.

In embodiments, the main controller 126 may receive vehicle presence signals from charging station sensors and adjust power allocation accordingly. For example, when an electric vehicle connects for charging, the controller 126 may temporarily reduce display power consumption to prioritize vehicle charging, particularly during periods of lower solar generation. The power management system 128 may implement charging algorithms that predict power consumption for multiple charging sessions and response by allocating solar generation and battery storage 138 capacity.

The content management system 144 may coordinate display content with charging station status, showing relevant information such as charging availability, waiting times, or energy pricing on displays 146 that are visible to approaching drivers and/or drivers that are parked for charging. For installations with multiple charging stations, the displays 146 may show real-time availability maps or reservation information. Additionally, the display systems may show targeted content to vehicle owners during charging sessions, including advertising, local information, or charging status updates.

In networked installations 100 with multiple solar array display systems 102A-N, the networked control systems 134 may optimize charging resources across the entire site, directing drivers to specific charging locations based on current availability, power generation conditions, grid demand, and/or other factors described herein. Such integrated installations may also participate in vehicle-to-grid (V2G) programs, for example by using the power management system 128 to coordinate bidirectional power flows between vehicles, solar arrays, and the grid based on economic signals and grid needs.

The solar array display systems may also incorporate or connect with security systems to enhance site safety and/or asset protection. In some embodiments, security systems may be physically integrated with the solar array structures, including lighting systems mounted on support poles or array edges, audio systems for alerts and announcements, and sensors for environmental and security monitoring.

In these embodiments, the main controller 126 may coordinate security functions with display operations, such as by adjusting security lighting based on ambient conditions or suspicious activity detection. For example, motion sensors detecting movement near the installation during off-hours may trigger the controller 126 to increase security lighting brightness, activate warning messages on displays 146, and/or issue audio alerts through integrated speaker systems.

In networked installations 100, the security functions may be coordinated across multiple solar array display systems 102A-N to create comprehensive site security. The networked control systems 134 may implement coordinated warning displays 146 that direct attention to specific areas or synchronized audio announcements across multiple arrays.

Bidirectional security integrations may allow the solar array display systems to receive security alerts from external systems and contribute to broader security networks. For instance, environmental sensors on the arrays may detect conditions like smoke, unusual heat signatures, or rising water levels and transmit this data to municipal emergency systems. Similarly, during public safety events, the arrays may receive emergency information from authorized systems and display appropriate warnings or instructions to the public.

The power management system 128 may also incorporate backup power provisions for security functions to ensure that security capabilities remain operational (e.g., during power outages) by prioritizing limited battery storage 138 resources. These capabilities may make the integrated security functions particularly valuable in remote installations or during emergency situations when conventional security systems may be compromised by power loss.

### Example Solar Array Display System Embodiments

The following example figures illustrate embodiments that combine solar arrays with various types of static and dynamic displays in various configurations. It should be understood that the following arrangements are exemplary and may be combined in different ways.

FIG. 1B shows a frontal perspective view of an example solar array installation 10, featuring solar array 20 comprising multiple solar modules 30. Solar array 20 is further mounted to pole 40, which is formed from steel or other suitable structural material. Pole 40, in turn, is affixed rigidly to base 50 typically by threaded nuts and bolts. Further, base 50 is generally constructed using a form and reinforced poured concrete into installation site ground 68. The example installation 10 shows one example of a solar array without an integrated display system to illustrate an example implementation of the solar power generation components 104 (which may include an array 20 including multiple solar modules 30), mounting and structural components 112 (which may include a pole 40, base 50, and ground 68).

FIG. 1C shows an example system 110 (which is an example of the solar array display system 102) that includes at least one solar module 30 combined with static overlay material 66 to form static solar module 130. The static solar array 120 is thereby formed from at least one static solar module 130 with corresponding portions of overlay material 66 to form a static image 60. The combined static image and solar array 120 may also include solar module(s) 30 that may comprise “blank space” (i.e., possessing no static overlay material 66) surrounding or within the static image 60. Static overlay material 66 may be formed from suitable colorants 122 and/or overlays 142, such as pigments, films, membranes, coatings, deposited materials, veneers, and/or thin substantially rigid panels and the like of any color, using one or more of the techniques described above. Further, the static image 60 may comprise any combination of text, iconography, and/or images of any size within the confines of the solar array 20 perimeter.

FIG. 1D shows an example closeup side view of a portion of a solar array 20, illustrating a full solar module 30 situated between a partial view of upper solar module 30a above, and a partial view of lower solar module 30b below. Each solar module 30 is also illustrated with a static overlay material 66 that in total forms the image embodied in static overlay 66. Static overlay material 66 may be affixed to solar module 30 by suitable adhesives, static adhesion, and/or other permanent or semi-permanent attachment methods.

FIG. 1E shows the same closeup side view of another example solar array 20 that is similar to the array 20 shown in FIG. 1D, however, this implementation includes platform 70 (which is an example of a platform 124) which is placed offset from and substantially parallel to solar module 30, separated by gap 90. Platform 70 is substantially transparent and may be formed from thermoplastics such as polycarbonate or acrylic, high-impact resistant glass, or other such suitable substantially transparent material. Further, platform 70 may be held rigidly in place by multiple platform spacer 80 components. Platform spacer 80 may be formed from stainless steel or other suitable weather-resistant materials. As seen in this example figure, static overlay material 66 is adhered to the external surface of platform 70.

FIG. 1F shows the same components illustrated in FIG. 1E, however, in this case static overlay material 66 is adhered to the interior surface of platform 70.

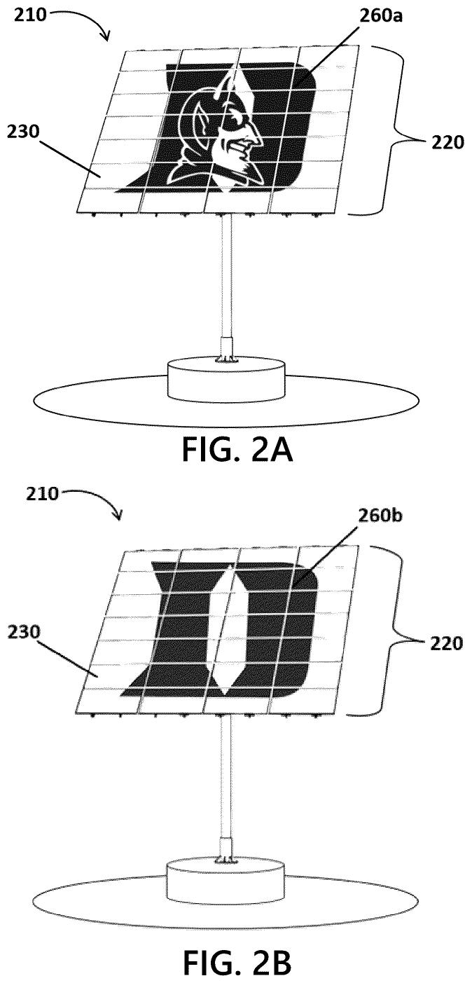

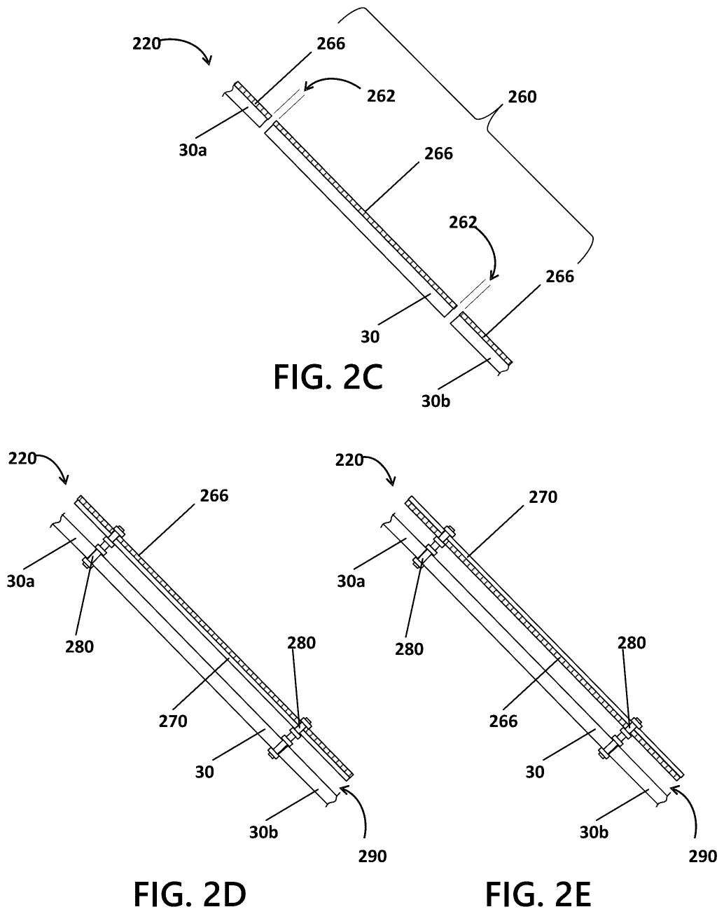

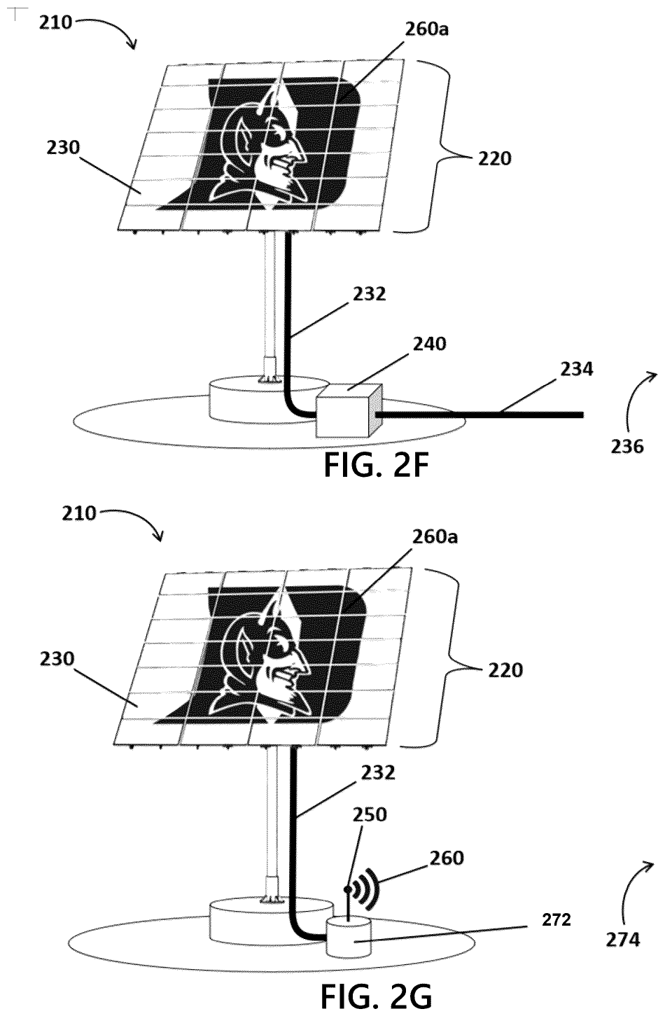

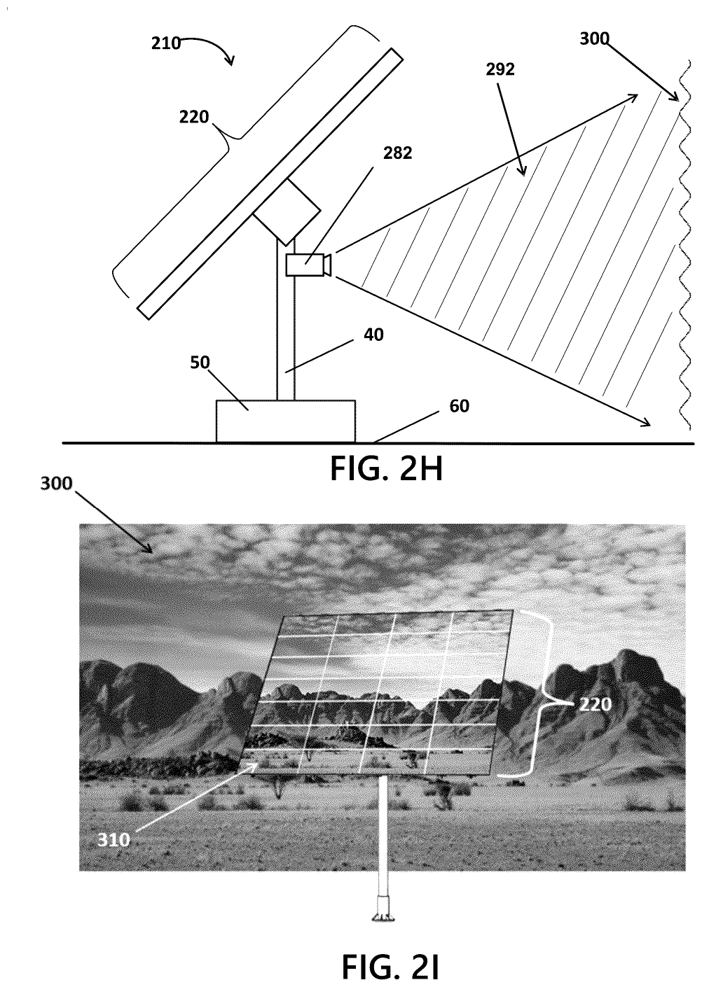

FIG. 2A illustrates another embodiment that comprises an example dynamic image solar installation 210 (which is another example of a solar array display system 102) that includes many of the same components shown previously in the example static image solar installation 110 (and described in FIGS. 1B and 1C), such as pole 40 and base 50. In this figure, however, one or more dynamic image solar module(s) 230 combine the standard power generation capability of solar module(s) 30, with the ability to display dynamic images. The one or more dynamic solar modules 230 may be combined into a dynamic image solar array 220 that produces dynamic image 260a, for example. In some installations, an array 210 may comprise both dynamic image solar module(s) 230 together with solar module(s) 30 (e.g., the array may include modules that have display capabilities and modules that do not have display capabilities in any arrangement).

FIG. 2B shows the dynamic image solar installation 210 of FIG. 2A showing an alternate dynamic image 260b (e.g., the same array 210 may change displayed images over time, such as by displaying sequential static images, animations, video, etc.).

FIG. 2C shows a closeup side view of a portion of an example dynamic image solar array 220, illustrating a full solar module 30 situated between a partial view of upper solar module 30a above, and a partial view of lower solar module 30b below. Each solar module 30 is also shown covered by dynamic display material 266. An assembly combining solar module 30 and dynamic display material 266 comprises a dynamic solar module 230. Dynamic display material 266 may be formed from a transparent LED film or other suitable material. Dynamic display material 266 may be affixed to solar module 30 by suitable adhesives or other permanent or semi-permanent attachment methods. One or more dynamic solar modules 230 may be combined within the array to display dynamic image 260. Additionally, platform 70 on any given solar module 30 may be situated to provide an in-plane notch 262 separating platform 70 on one or more adjacent solar module 30. In-plane notch 262 may prove advantageous to allow thermodynamic cooling through forced (e.g., wind-driven) and natural convection processes. In other embodiments, in-plane notch 262 may be substantially closed (not shown) with an adjacent platform 70 forming a substantially contiguous surface accomplished through butt- or lap-joints and the like. This arrangement may prove useful, for example, in forming a substantially contiguous application of display material 266 forming dynamic image 260.

FIG. 2D shows the same closeup side view of another example dynamic solar array 220 that is similar to the array 220 shown in FIG. 2C, however, this implementation includes display platform 270 which is placed offset from and substantially parallel to solar module 30, separated by gap 290. Display platform 270 is substantially transparent and may be formed from thermoplastics such as polycarbonate or acrylic, high-impact resistant glass, or other such suitable substantially transparent material. Further, display platform 270 may be held rigidly in place by multiple display spacer 280 components. Display spacer 280 may be formed from stainless steel or other suitable weather-resistant materials. As seen in this example figure, dynamic display material 266 is shown placed on the external surface of display platform 270.

FIG. 2E shows the same components illustrated in FIG. 2D, however, in this case dynamic display material 266 is shown placed on the interior surface of display platform 270.

FIG. 2F displays an example dynamic solar array installation 210 (e.g., as illustrated in FIGS. 2A-2D), and shown to include a wired controller 240 (which may implement the functions of the main controller 126, other control systems 140, and/or display controllers 148), connected electrically to the array dynamic image solar modules 230 by display conduit 232. Wired controller 240 dictates individual dynamic solar module 230 display output and choreographs the overall dynamic image 260 display. The controller 240 is further connected by external display conduit 234 to one or more other control systems 140 (not shown) and communicates bidirectionally through suitable protocols such as Ethernet. The control systems 140 may be a standalone or networked computing device such as a microcontroller, computer, or server that may perform various functions as described herein.

FIG. 2G displays an example dynamic solar array installation 210 (e.g., as illustrated in FIGS. 2A-2F, however, a wireless controller 272 (which may implement the functions of the main controller 126, other control systems 140, and/or the display controller 148) is connected to dynamic solar modules 230 by display conduit 232. The wireless controller 272 communicates wirelessly and bidirectionally through antenna 250 to other wireless devices 274 (not shown) by suitable protocols such as WiFi and/or Bluetooth. The wireless devices 274 may be (and/or may be in communication with) a microcontroller, computer, or server that may perform various functions as described herein (e.g., control systems 140 and/or networked control systems 134).

FIG. 2H shows a side view of an example dynamic solar array installation 210 (e.g., as illustrated in FIGS. 2A-2G, including dynamic solar array 220, mounted to ground 68 through pole 40 and base 50. This example installation 210 also includes camera 282, shown facing substantially backwards behind the array, with field of view 292 capturing scene 300. As described above, images and/or video captured by the camera 282 may be processed (e.g., by a controller 126 and/or other computing device) to generate one or more images and/or video for display via the dynamic solar array 220.

FIG. 2I illustrates an example frontal perspective view of the dynamic solar installation 210 shown in FIG. 2H, with scene 300 captured by camera 282 (not shown, see FIG. 2H) and displayed superimposed on dynamic solar array 220.

FIG. 3A shows an example frontal perspective view of another solar array installation 310 (which is another example of a solar array display system 102) comprising as a basis, solar array installation 10 (e.g., as shown in FIG. 1B), including solar array 20 comprising multiple solar modules 30. Solar array 20 is further mounted to pole 40 and base 50. In addition, a proximal optical projector 330 is mounted to solar array 20 by projector bracket 340, although it should be understood that other mounting mechanisms may be used. Proximal projector 330 is configured suitably to illuminate via projector lens 334 substantially all of solar array 20 (shown figuratively by projection lines 350) and render projected imagery 360 directly to the surface of solar array 20. In so doing, solar array 20 acts much as a cinematic movie screen, allowing static and dynamic images to be displayed without the need for further modifications to solar array 20. Proximal projector 330 may be of analog or digital format, and, similar to the content shown FIGS. 2F and 2G, proximal projector 330 may be fed programmable video content by local or remote content sources, such as analog or digital video. While only one optical projector is shown, it should be understood that multiple proximal projector 330 outputs may be combined to provide spatially independent and programmed projected content, or content that is combined or otherwise overlayed. Further, though FIG. 3A illustrates proximal projector 330 and projector bracket 340 situated underneath solar array 20, they may be situated in multiple locations, such the array sides, top, and or bottom. As a further enhancement, solar array 20 may be oriented (in programmed pitch and yaw, for example) to optimize projected content visibility. In one example, solar array 20 may be oriented vertically to maximize projected viewing area. Further, such preferential orientations may be performed in less advantageous solar conditions, such as night, effectively converting the solar array from a power production function during day, to a nighttime content screen for entertainment and advertising purposes, etc.

FIG. 3B illustrates an alternate embodiment of the example solar array installation 310 shown in FIG. 3A, with proximal optical projector 330 of FIG. 3A. replaced by remote projector 370. In this embodiment, remote projector 370 is supported by projector pole 380 fixed in projector foundation 390. While a “ground mount” arrangement is shown here, it should be understood that remote projector 370 may be situated in multiple ways, such as projected up to, level with, or down onto solar array 20 from adjacent buildings or other suitable structures. As in FIG. 3A, multiple remote projectors 370 may be employed to render spatially distinct or combined images.

FIG. 4A depicts a frontal perspective view of another solar array 410 (which may be based on the solar array 310 shown in FIGS. 3A and 3B, and is another example of a solar array display system 102), including the array-mounted optical projector 330 mounted to solar array 20 by projector bracket 340. The array also includes a screen bin 420 (detailed later in FIG. 4C) containing a rolled deployable screen 424 (shown later in FIG. 4B). Deployable screen 424 may be made from a suitable flexible viewing screen material such as silvered mylar. Deployable screen 424 may also be configured of materials that are substantially reflective at night, but can also allow substantial sunlight to pass through during daytime operations, for additional usage flexibility. The upper edge of deployable screen 424 is rigidly affixed to screen bar 428 such that screen bar 428 runs substantially the full width of the upper edge of deployable screen 424. Deployable screen 424 vertical side edges may slide within and may be constrained within screen edge 425. Screen bar 428 may also be rigidly connected to at least one screen cable 430 that is tensioned over roller motor 435 at the top of solar array 20. Roller motor 435 may be one or more of any suitable electrically driven rotary motor. Rotary motion of roller motor 435 will place tension on screen cable 430, which will in turn raise screen bar 428 and likewise the upper edge of deployable screen 424, unrolling deployable screen 424 from within screen bin 420. Tension on deployable screen 424 is assisted by the weight of the screen itself. In addition, screen bin 420 may also employ tensioning means such as a rotary spring to enhance deployable screen 424 flatness and aid restowing of the screen into screen bin 420 (please see FIG. 4G). It should be understood that the depicted screen bin may be mounted on various sides of the solar array, such that the screen may deploy in other orientations (e.g., side-to-side, bottom-to-top, or top-to-bottom).

The screen bin 420 may serve as a protective housing for the deployable screen 424 when not in use. The screen bin 420 may be constructed from weather-resistant materials such as anodized aluminum, marine-grade stainless steel, UV-resistant polymers, composite materials, or the like. To protect the screen from environmental elements, the screen bin 420 may be sealed against moisture, dust, and debris ingress (e.g., using elastomeric gaskets or seals) at joints and openings. The screen bin 420 may incorporate a weatherproof lip or flange that seals against the bottom edge of the screen when fully retracted, preventing water intrusion. This sealing mechanism may use compression gaskets, brush seals, other appropriate mechanisms to maintain an environmental barrier while also accommodating screen movement. Drain holes with one-way valves may be incorporated at the bottom of the screen bin 420 to allow for drainage of any accumulated moisture.

Although the deployable screen 424 is described herein as implementing a projector screen, it should also be noted that flexible active displays 146 (e.g., flexible OLED displays, flexible electronic paper displays) may also be stowed (e.g., rolled) and deployed in a similar manner as described herein. Accordingly, the deployable screen 424 may be an active display component in some cases. In these embodiments, projection equipment may not be needed and/or may be used as a backup, to enhance the active display, and/or otherwise may be used such that the deployable screen 424 may act as a projection display and an active display.

FIG. 4B illustrates the example array 410 shown in FIG. 4A with the deployable screen 424 moving upward and shown positioned in mid-deployment, partially covering solar array 20. It should be noted that screen bar 428 helps maintain flatness of deployable screen 424 as it covers array 20, and helps ensure even deployment. It should be noted that while a deployment sequence is being illustrated, reversing direction of roller 435 will cause deployable screen 424 to retract (and stow) into screen bin 420.

FIG. 4C shows the example array 410 previously described in FIGS. 4A and 4B with the deployable viewing screen in the fully deployed position, with screen bar 428 positioned substantially at the top of solar array 20 and deployable screen 424 covering substantially all solar array 20. In addition, optical projector 330 is shown displaying programmable static and dynamic images onto deployable screen 424.

For additional clarity, FIGS. 4D, 4E, and 4F illustrate (in side view) the screen deployment sequence seen in FIGS. 4A, 4B, and 4C. In each of these figures, optical projector 330 is omitted for clarity.

FIG. 4D is a side view of the example solar array 410 in FIG. 4A, highlighting several functional elements that enable the example deployable screen 424 to move from a stowed position within screen bin 420 to being fully deployed across solar array 20. In this view, screen cable 430 lays across array 20, spanning screen bar 428 and roller motor 435.

FIG. 4E is a side view of the example solar array 410 in FIG. 4B, showing deployable screen 424 pulled by screen bar 428 into a mid-deployment position. Further clockwise rotation of roller motor 435 will pull (via. screen cable 430) bar 428 closer to roller motor 435.

FIG. 4F is a side view of the example solar array 410 in FIG. 4C, showing deployable screen 424 in the fully deployed position, with screen cable 430 stowed on roller motor 435, and with deployable screen 424 substantially covering the entirety of array 20.

FIG. 4G shows a cross-sectional depiction of the example solar array 20 of FIG. 43, showing deployable screen 424 in a mid-deployment position. As seen here, screen bin 420 houses screen scroll 440 that is a wound configuration of deployable screen 424. Screen scroll 440 is wound around screen pivot 450, both of which are housed in screen bin 420. As roller motor 435 winds clockwise in this view tensioning screen cable 430 and screen bar 428, deployable screen 424 is fed from its wound configuration depicted in screen scroll 440. As mentioned previously, screen pivot 450 may provide additional tensioning means for deployable screen 424 through such measures as a rotary spring, or an additional rotary motor (not shown) that works in concert with roller motor 435 to facilitate deployment and retraction/stowing of deployable screen 424.

FIG. 5A depicts a frontal perspective view of another solar array installation 510 (which may be based on the solar array installation 10 shown in FIG. 1B, and provides another example of a solar array display system 102), including solar array 20 comprising multiple solar modules 30. Solar array 20 is further mounted to pole 40, which is affixed rigidly to base 50. Further, solar array 510 includes at least one display tube 500, which, in this embodiment, takes the form of a fixed substantially cylindrical surface surrounding pole 40. Display tube 500 may include on its exterior a thin-film display screen material (such as LCD format) wrapped upon a suitable structural frame, thereby creating a contiguous circumferential screen which may be used for displaying static and/or dynamic content 520. The display may be configured to fully or partially wrap around the pole to provide up to a full 360-deg contiguous display circumference that enables effectively accommodating one or more content viewers 555, who may be arranged at various lines of sight 560. Display tube 500 may be programmed to display static and/or dynamic content 520 in a similar fashion to the means described previously herein. It should be appreciated that display tube 500 may be installed at various heights on pole 40 and may be fashioned in a variety of lengths. It should be further appreciated that while the preferred embodiment of display tube 500 is substantially cylindrical, it may nevertheless take the form cross sectionally as polygons, ellipses, freeform lines and curves and the like that may or may not be centered on pole 40. Although the screen may fully wrap around the pole 40 to create a contiguous display surface, it is within the scope of this description to include segmented or otherwise non-closed display perimeters.

FIG. 5B shows solar array installation 510 described in FIG. 5B, including display tube 500. However, in this embodiment, instead of being fixed, at least one display tube 500 is positionable vertically along the length of pole 40, allowing display tube 500 to move between an initial position 530 to a secondary position 540. This motion may prove advantageous to better tailor display information to specific events such as time of day, ambient lighting, and/or the like, or to raise display tube 500 up under solar array 20 to provide protection from adverse weather conditions. In addition, such vertical motion may help to accommodate one or more content viewers 555, allowing at least one viewer primary line of sight, as well as a multiplicity of alternate viewer lines of sight. Display tube 500's vertical motion may be accomplished through direct drive electrical motors, gearing, and pulleys, or any other suitable means. The positioning of the display tube 500 may further be programmable to integrate with other solar array 20 attitude control means.

FIG. 5C depicts a frontal perspective view of another solar array installation 510 shown in FIGS. 5A and 5B, and, as before, includes solar array 20 comprising multiple solar modules 30. Solar array 20 is further mounted to pole 40, which is affixed rigidly to base 50. Further, solar array 510 includes at least one panel screen assembly 550, which comprises a suitable television-like housing containing display materials such as LED or LCD. Panel screen assembly 550 is further rigidly affixed to pole 40, and may be mounted at a height, radial pan direction, and vertical tilt angle so that it may be viewed most advantageously by content viewer 555 with primary line of sight 560. It should be appreciated that panel screen assembly 550 may be a flat or curved configuration, and may have any suitable vertical and horizontal size and screen aspect ratio, any mounting position on pole 40, etc. In addition, panel screen assembly 550 may include suitable ruggedization/weatherproofing measures to prevent intrusion of water and debris into the assembly. Panel screen 550 may be mounted to pole 40 using any suitable bracket, harness, and/or truss structures as required. As described previously, panel screen 550 may be programmed to display static and dynamic content.

FIG. 5D shows a closeup view of solar array installation 510 described in FIG. 5C, including panel screen 550. However, in this embodiment, instead of being in a fixed configuration, at least one panel screen 550 is positionable radially about pole 40 centerline 570, allowing panel screen 550 to pan to any radial orientation 575. In addition, panel screen 550 may also rotate about a substantially horizontal axis 580, allowing panel screen 550 to orient to a tilt position 585 (such as, for example, up and down 30 degrees). These motions, individually or combined, may prove advantageous to better tailor display information to at least one content viewer 555 along a line of sight 560. Such motion, in addition, may help accommodate (or compensate for) specific events such as time of day, ambient lighting intensity, and/or ambient lighting direction.

FIG. 6A depicts another solar array assembly (which is another example of a solar array display system 102) that combines any of the solar array static and/or dynamic image arrays 620 displaying content 630 previously described (e.g., as described above with respect to any of FIGS. 1B-4G), in combination with the pole-mounted display content described in FIGS. 5A-5D, demonstrated here by display tube 500 showing display tube content 520. Array-based and pole-based static and dynamic content may be coordinated or separately programmed, (e.g., so the displays may act in concert with each other or independently). It may be appreciated that static and dynamic content may further be programmed to accommodate solar array directionality, allowing, for example, the array-based content to be directed at a different content viewer (or viewers) than the pole-based content.

FIG. 6B illustrates the solar array assembly of FIG. 6A. with the previously described static and dynamic content accentuated by audio programming 650 supplied by at least one speaker 660. Audio programming 650 may be programmed to be independent and/or substantially synchronized with the static and/or dynamic image content displayed using the various array- and/or pole-based display means previously described. It should be appreciated that speaker 660 may be positioned in any suitable location, including on the array 620, pole 40, base 50, and/or surrounding terrain, and any combination thereof. Speaker 660 may be configured to accommodate analog and digital input in mono, stereo, etc. and multi-speaker configurations such as sub-woofer, woofer, mid-range, and tweeter, etc. Further, speaker 660 may be passive or self-powered, and accept wired and/or wireless audio inputs. It should be appreciated that speaker 660 may be added independently to any of the previous concepts, including arrays with no visual content. Such an installation might be used to provide ambient audio content, such as music.

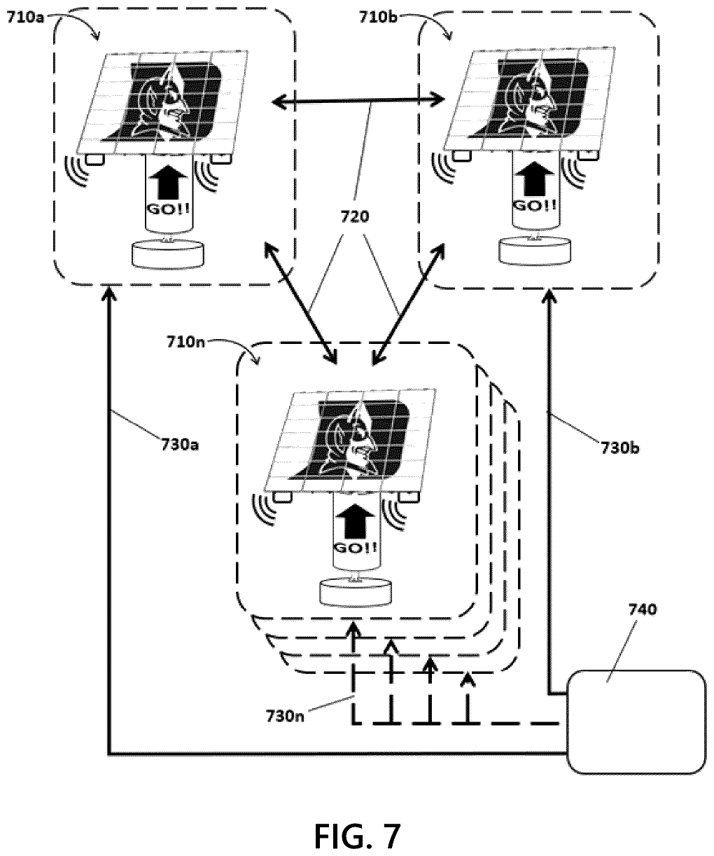

FIG. 7 depicts at least two of the solar array assemblies described in FIG. 6B (thereby forming a multi-array installation 100) shown as array assembly 710a and 710b respectively, that are networked by connections 730a and 730b to a common controller 740 (e.g., a networked control system 134). Multiple additional array instances, shown collectively as array assembly 710n may also be connected to common controller 740, through their own dedicated connections 730n. Connections 730a, 730b, and 730n may take the form of physical wired cabling, wireless connections, and/or any combination thereof. In this “networked” configuration, static and dynamic visual content and audio output on any one array assembly may be coordinated with the content on at least one other array comprising the network. Two or more arrays may demonstrate affinity lines 720, that is, visual and audio content that appears to “move” between arrays in a choreographed fashion. More generally, any visual and audio content may (or may not) be displayed by any one array assembly, allowing significant content programming flexibility. In addition, controller 740 function can be sub-divided into one or more sub-controllers (not shown) and be located either centrally or distributed among arrays and/or any combination thereof. Further, controller 740 function may be spatially flexible, so that arrays over local and wide geographic areas may be coordinated, such as by using internet protocol (IP) functionality for convenience.

In embodiments involving the display of content across multiple arrays, the one or more controllers 740 may control the placement of content across the multiple arrays 710 in real-time, such as by breaking up larger visual content into “chunks” that are distributed across the multiple arrays, controlling the movement of visual content from array to array over time, and/or the like. Thus, the controller(s) 740 may generate and transmit multiple streams of content via the network, which may be addressed to various individual displays 146 associated with the various arrays 710. Additionally or alternatively, the controller(s) 740 may transmit positioning instructions that may instruct individual array(s) 710 to perform various actions, such as adjusting rotation tilt (e.g., horizontally and/or vertically) of the array or pole-mounted display, vertical positioning of the pole mounted display, deployment of projection screens, and/or the like. For example, the controller(s) 740 may reposition arrays and/or displays 146 in real-time to optimize the display of visual content over time, to switch between power generation and display modes, to reposition displays based on a line of sight to a viewer or viewers, and/or the like. Additionally or alternatively, the controller(s) 740 may generate multiple audio streams for rendering audio content across multiple arrays, such as to create synchronized audio presentations, provide for “surround sound” effects, and/or the like.

FIG. 8A depicts a frontal perspective view of another example solar array installation 810 (which is another example solar array display system 102) comprising solar array 20 with multiple solar modules 30, mounted to pole 40 which is affixed rigidly to base 50. This example embodiment features a peripheral display panel 830 attached to a lower edge structure of solar array 20. Display panel 830 may include any of the dynamic display technologies previously described, such as LCD, LED, or other suitable thin-film displays, and is configured to display programmable content 820, which may include static and/or dynamic visual content. The positioning of display panel 830 at the lower edge of solar array 20 allows for visibility to ground-level viewers while avoiding any obstruction of solar insolation to the solar modules 30. Display panel 830 may be controlled using any of the previously described wired or wireless controllers (e.g., as described with respect to FIGS. 2F and 2G) to display visual content. As with other embodiments described herein, the content may be coordinated across multiple installations (e.g., as described with respect to FIG. 7) and/or combined with audio content from speakers (e.g., as described with respect to FIG. 6B).

FIG. 8B shows the example solar array installation 810 of FIG. 8A, further demonstrating an example of how multiple display techniques described herein may be combined. In this embodiment, peripheral display panel 830 displaying content 820 is combined with static overlay material 66 forming static image 60 on the solar array 20 surface. The static overlay material 66 may incorporate any of the previously described techniques for minimizing insolation degradation, such as selective pigment materials, patterns, opacity levels, and/or panel usage percentages (e.g., as described above). While this figure illustrates a specific combination of a peripheral dynamic display with static overlay material, it should be understood that any combination of the static, dynamic, projected, and/or pole-mounted display techniques described throughout this disclosure may be combined as desired for particular installations. In other words, FIG. 8B illustrates a specification combination of techniques, but it should also be understood that the various techniques described herein may be combined in various other ways.

FIG. 8C illustrates a side view of the solar array installation 810 (e.g., the example shown in FIG. 8A and/or 8B), highlighting an articulating mount 840 that enables display panel 830 to rotate about a rotational axis as indicated by rotational motion 850. This articulation allows the display panel 830 to be positioned at various angles to optimize visibility for a content viewer 555 along the line of sight 560, similar to the positioning capabilities described for the pole-mounted displays (e.g., as shown in FIG. 5D). A controller (e.g., controller 126) may adjust the articulation to adjust viewing angles based on intended viewer position—for example, allowing for comfortable viewing from ground level or from various distances. The rotational positioning may be controlled by motors or other suitable mechanical actuators, which may be governed by the same control systems described previously for other display embodiments. In embodiments, these control systems may adjust the panel angle based on factors including time of day, expected viewer positions, weather conditions, and/or coordinated display presentations across multiple installations, as described above. Additionally, the controller may adjust the panel position based on a corresponding rotation or repositioning of the solar array itself, thereby allowing for optimization of both power generation and content visibility.

### CONCLUSION

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The various methods and systems described herein, including the controllers and systems described herein, may be deployed in part or in whole one or more systems that execute computer software, program codes, and/or instructions on a processor. The present disclosure may be implemented as a method on the system, as a subsystem or apparatus as part of or in relation to the system, or as a computer program product embodied in a computer readable medium executing on one or more of the systems. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any system utilizing one, may include non-transitory memory that stores methods, codes, instructions, and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through a system that executes computer software on a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, systems, and devices through a wired or a wireless medium, and the like. The methods, programs, or codes described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code, and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client, and the like. The client may include one or more of memories, processors, computer readable media, storage media, ports (physical and virtual), communication devices, and interfaces capable of accessing other clients, servers, systems, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on systems through computer executable code using a processor capable of executing program instructions stored thereon as a monolithic software structure, as standalone software modules, or as modules that employ external routines, code, services, and so forth, or any combination of these, and all such implementations may be within the scope of the present disclosure. Examples of such systems may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams, or any other logical component may be implemented on a system capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other system capable of executing program instructions. Computer software may employ virtualization, virtual machines, containers, dock facilities, portainers, and other capabilities.

Thus, in one aspect, methods described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

All documents referenced herein are hereby incorporated by reference as if fully set forth herein.

1. A solar array display system, comprising:
a plurality of solar modules configured to convert solar energy into electrical power;
at least one display operably connected to the plurality of solar modules, wherein the at least one display is configured to present visual content; and
a control system operably coupled to the plurality of solar modules and the at least one display, the control system comprising:
a power management system configured to:
monitor power generation of the plurality of solar modules;
control power allocation between the plurality of solar modules and the at least one display; and
a content management system configured to:
store visual content for display on the at least one display;
select a subset of the visual content based on at least one operational parameter of the solar array display system; and
control presentation of the selected subset of visual content on the at least one display,
wherein the control system is configured to dynamically balance power generation by the plurality of solar modules and presentation of visual content by the at least one display based on at least one operational priority.

2. The solar array display system of claim 1, wherein the power management system is further configured to adjust positioning of at least one of the plurality of solar modules to balance power generation and display visibility.

3. The solar array display system of claim 1, wherein the at least one display comprises a transparent or semi-transparent display positioned over at least one of the plurality of solar modules.

4. The solar array display system of claim 1, wherein the at least one display comprises a peripheral display mounted to an edge portion of a supporting structure that holds the plurality of solar modules.

5. The solar array display system of claim 1, wherein the at least one display comprises a pole-mounted display connected to a support pole that supports the plurality of solar modules.

6. The solar array display system of claim 5, wherein the pole-mounted display is configured to articulate independently of the plurality of solar modules.

7. The solar array display system of claim 1, wherein the at least one display comprises a projector configured to project visual content onto at least one of: the plurality of solar modules or a deployable screen.

8. The solar array display system of claim 7, further comprising a deployable screen movable between a stowed position and a deployed position covering at least a portion of the plurality of solar modules.

9. The solar array display system of claim 1, wherein the at least one operational parameter comprises at least one of: current power generation, stored power level, time of day, weather conditions, display visibility, or content priority.

10. The solar array display system of claim 1, wherein the at least one operational priority comprises at least one of: power generation priority, revenue generation priority, or information display priority.

11. The solar array display system of claim 1, wherein the content management system is further configured to select the subset of the visual content based at least partially on a power consumption impact of the visual content.

12. The solar array display system of claim 1, wherein the control system is further configured to override current operational priorities in response to receiving emergency notification content for display.

13. The solar array display system of claim 1, wherein the control system is further configured to communicate with external systems to receive content for display or operational instructions.

14. The solar array display system of claim 1, further comprising a storage system configured to store excess power generated by the plurality of solar modules.

15. The solar array display system of claim 1, wherein the solar array display system is one of a plurality of solar array display systems in a networked installation, and wherein the content management system is configured to coordinate visual content across the plurality of solar array display systems.

16. The solar array display system of claim 1, further comprising at least one sensor configured to collect data related to at least one of ambient light conditions, solar irradiance, or viewer presence, wherein the content management system is configured to select the subset of the visual content based at least partially on data from the at least one sensor.

17. The solar array display system of claim 1, wherein the content management system is further configured to adjust brightness of the at least one display based on current power generation by the plurality of solar modules.

18. The solar array display system of claim 1, further comprising a static visual overlay applied to at least a portion of at least one of the plurality of solar modules, wherein the static visual overlay is configured to display static visual content while allowing solar radiation to reach the solar module.

19. The solar array display system of claim 1, wherein the power management system is further configured to monitor external power grid conditions and adjust the balance between power generation and presentation of visual content based at least partially on the external power grid conditions.

20. The solar array display system of claim 1, wherein the control system is configured to implement a revenue optimization mode that evaluates potential revenue from power generation versus display of advertising content.
